(19) United States
(12) Patent Application Publication
(10) Pub. No.: US 2024/0320562 A1
(43) Pub. Date: Sep. 26, 2024

(54) ADVERSARIAL ROBUSTNESS OF DEEP LEARNING MODELS IN DIGITAL PATHOLOGY

(71) Applicant: Ventana Medical Systems. Inc., Tucson, AZ (US)

(72) Inventors: Qinle Ba, Tucson, AZ (US); Jungwon Kim, Tucson, AZ (US); Jim F. Martin, Mountain View, CA (US); Joachim Schimid, Tucson, AZ (US); Xingwei Wang, Tucson, AZ (US)

(73) Assignee: Ventana Medical Systems. Inc., Tucson, AZ (US)

(21) Appl. No.: 18/680,974

(22) Filed: May 31, 2024

Related U.S. Application Data
(63) Continuation of application No. PCT/US2022/051565, filed on Dec. 1, 2022.
(60) Provisional application No. 63/293,430, filed on Dec. 23, 2021.

(51) Int. Cl. G06N 20/00

(52) U.S. Cl. CPC G06N 20/00

(57) ABSTRACT

The present disclosure relates to techniques for pre-processing training data, augmenting training data, and using synthetic training data to effectively train a machine learning model to (i) reject adversarial example images, and (ii) detect, characterize and/or classify some or all regions of images that do not include adversarial example regions. Particularly, aspects of the present disclosure are directed to receiving a training set of images for training a machine learning algorithm to detect, characterize, classify, or a combination thereof some or all regions or objects within the images, augmenting the training set of images with synthetic images generated from one or more adversarial algorithms to generate augmented batches of images, and train the machine learning algorithm using the augmented batches of images to generate a machine learning model configured to detect, characterize, classify, or a combination thereof some or all regions or objects within new images.

### CROSS-REFERENCE TO RELATED APPLICATIONS

The present application is a continuation of International Application No. PCT/US2022/051565, filed on Dec. 1, 2022, which claims priority to U.S. Provisional Patent Application No. 63/293,430 filed on Dec. 23, 2021, each of which are hereby incorporated by reference in their entireties for all purposes.

### FIELD

The present disclosure relates to digital pathology, and in particular to techniques for pre-processing training data, augmenting training data, and using synthetic training data to effectively train a machine learning model to (i) reject adversarial example images, and (ii) detect, characterize and/or classify some or all regions of images that do not include adversarial example regions.

### BACKGROUND

Digital pathology involves scanning of slides (e.g., histopathology or cytopathology glass slides) into digital images interpretable on a computer screen. The tissue and/or cells within the digital images may be subsequently examined by digital pathology image analysis and/or interpreted by a pathologist for a variety of reasons including diagnosis of disease, assessment of a response to therapy, and the development of pharmacological agents to fight disease. In order to examine the tissue and/or cells (which are virtually transparent) within the digital images, the pathology slides may be prepared using various stain assays (e.g., immunohistochemistry) that bind selectively to tissue and/or cellular components. Immunofluorescence (IF) is a technique for analyzing assays that bind to fluorescent dyes to antigens. Multiple assays responding to various wavelengths may be utilized on the same slides. These multiplexed IF slides enable the understanding of the complexity and heterogeneity of the immune context of tumor microenvironments and the potential influence on a tumor's response to immunotherapies. In some assays, the target antigen in the tissue to a stain may be referred to as a biomarker. Thereafter, digital pathology image analysis can be performed on digital images of the stained tissue and/or cells to identify and quantify staining for antigens (e.g., biomarkers indicative of various cells such as tumor cells) in biological tissues.

Machine learning techniques have shown great promise in digital pathology image analysis, such as in cell detection, counting, localization, classification, and patient prognosis. Many computing systems provisioned with machine learning techniques, including convolutional neural networks (CNNs), have been proposed for image classification and digital pathology image analysis, such as cell detection and classification. For example, CNNs can have a series of convolution layers as the hidden layers and this network structure enables the extraction of representational features for object/image classification and digital pathology image analysis. In addition to object/image classification, machine learning techniques have also been implemented for image segmentation. Image segmentation is the process of partitioning a digital image into multiple segments (sets of pixels, also known as image objects). The goal of segmentation is to simplify and/or change the representation of an image into something that is more meaningful and easier to analyze. For example, image segmentation is typically used to locate objects such as cells and boundaries (lines, curves, etc.) in images. To perform image segmentation for large data (e.g., whole slide pathology images), the image is first divided into many small patches. A computing system provisioned with machine learning techniques is trained to classify each pixel in these patches, all pixels in a same class are combined into one segmented area in each patch, and all the segmented patches are then combined into one segmented image (e.g., segmented whole-slide pathology image). Thereafter, machine learning techniques may be further implemented to predict or further classify the segmented area (e.g., positive cells for a given biomarker, negative cells for a given biomarker, or cells that have no stain expression) based on representational features associated with the segmented area.

### SUMMARY

In digital pathology, inter-scanner and inter-laboratory differences may cause intensity and color variability within the digital images. Further, poor scanning may lead to gradient changes and blur effects, assay staining may create stain artifacts such as background wash, and different tissue/patient samples may have variances in cell size. These variations and perturbations can negatively affect the quality and reliability of a deep learning (DL) and artificial intelligence (AI) network. To address these challenges and others, disclosed are methods, systems, and computer readable storage media for pre-processing training data, augmenting training data, and using synthetic training data to effectively train a machine learning model to (i) reject adversarial example images, and (ii) detect, characterize and/or classify some or all regions of images that do not include adversarial example regions.

In various embodiments, a computer-implement method is provided that comprises: obtaining, at a data processing system, a training set of images for training a machine learning algorithm to detect, characterize, classify, or a combination thereof some or all regions or objects within the images; augmenting, by the data processing system, the training set of images with adversarial examples, wherein the augmenting comprises: inputting the training set of images into one or more adversarial algorithms, applying the one or more adversarial algorithms to the training set of images in order to generate synthetic images as the adversarial examples, wherein the one or more adversarial algorithms are configured, for each of the images, one or more regions of interest within the images, one or more channels of the images, or one or more fields of view within the images, to fix values of one or more variables while changing the values of one or more other variables to generate the synthetic images with various levels of one or more adversarial features, and generating augmented batches of images comprising images from the training set of images and the synthetic images from the adversarial examples; and training, by the data processing system, the machine learning algorithm using the augmented batches of images to generate a machine learning model configured to detect, characterize, classify, or a combination thereof some or all regions or objects within new images.

In some embodiments, the training set of images are digital pathology images comprising one or more types of cells.

In some embodiments, the one or more other variables are intensity, chrominance, or both for pixels in each of the images, the one or more regions of interest within the images, the one or more channels of the images, or the one or more fields of view within the images.

In some embodiments, the one or more other variables are a degree of smoothing, a degree of blur, a degree of opacity, a degree of softness, or any combination thereof for pixels in each of the images, the one or more regions of interest within the images, the one or more channels of the images, or the one or more fields of view within the images.

In some embodiments, the one or more other variables are a scaling factor for changing a size of objects depicted in each of the images, the one or more regions of interest within the images, the one or more channels of the images, or the one or more fields of view within the images.

In some embodiments, the one or more adversarial algorithms are configured, for a first channel of the one or more channels of the images, to fix the values of the one or more variables while changing the values of a first variable of the one or more other variables, and for a second channel of the one or more channels of the images, to fix the values of the one or more variables while changing the values of a second variable of the one or more other variables.

In some embodiments, the one or more adversarial algorithms are configured, for a first channel of the one or more channels of the images, to fix the values of a first variable of the one or more variables while changing the values of a first variable of the one or more other variables, and for a second channel of the one or more channels of the images, to fix the values of a second variable of the one or more variables while changing the values of a second variable of the one or more other variables.

In some embodiments, the training comprises performing iterative operations to learn a set of parameters to detect, characterize, classify, or a combination thereof some or all regions or objects within the augmented batches of images that maximizes or minimizes a cost function, wherein each iteration involves finding the set of parameters for the machine learning algorithm so that a value of the cost function using the set of parameters is larger or smaller than a value of the cost function using another set of parameters in a previous iteration, and wherein the cost function is constructed to measure a difference between predictions made for some or all the regions or the objects using the machine learning algorithm and ground truth labels provided for the augmented batches of images.

In some embodiments, the method further comprises providing the machine learning model.

In some embodiments, the providing comprises deploying the machine learning model in a digital pathology system.

In various embodiments, a computer-implement method is provided that comprises: obtaining, by a data processing system, a set of digital pathology images comprising one or more types of cells; inputting, by the data processing system, the set of digital pathology images into one or more adversarial algorithms; applying, by the data processing system, the one or more adversarial algorithms to the set of digital pathology images in order to generate synthetic images, wherein the one or more adversarial algorithms are configured, for each of the images, one or more regions of interest within the images, one or more channels of the images, or one or more fields of view within the images, to fix values of one or more variables while changing the values of one or more other variables to generate the synthetic images with various levels of one or more adversarial features; evaluating, by the data processing system, performance of a machine learning model to make an inference with respect to some or all regions or objects within the set of digital pathology images and the synthetic images; identifying, by the data processing system, a threshold level of adversity at which the machine learning model can no longer accurately make the inference based on the evaluating; applying, by the data processing system, a range of adversity above the identified threshold level as a ground-truth label in a training set of images; and training, by the data processing system, a machine learning algorithm using the training set of images to generate a revised machine learning model configured to identify adverse regions and exclude the adverse regions from downstream processing or analysis.

In some embodiments, the revised machine learning model is further configured to detect, characterize, classify, or a combination thereof some regions or objects within new images without consideration of the adverse regions.

In some embodiments, the method further comprises: receiving, by the data processing system, a new image; determining, by the data processing system, a range of adversity for the new image; comparing, by the data processing system, the range of adversity to the threshold level of adversity; when the range of adversity for the new image is greater than the threshold level of adversity, rejecting, by the data processing system, the new image; and when the range of adversity for the new image is less than or equal to the threshold level of adversity, inputting, by the data processing system, the new image into the revised machine learning model.

In some embodiments, the method further comprises: augmenting, by the data processing system, the training set of images with adversarial examples, wherein the augmenting comprises: inputting the training set of images into the one or more adversarial algorithms, applying the one or more adversarial algorithms to the training set of images in order to generate synthetic images as the adversarial examples, wherein the one or more adversarial algorithms are configured, for each of the images, one or more regions of interest within the images, one or more channels of the images, or one or more fields of view within the images, to fix values of one or more variables while changing the values of one or more other variables based on the threshold level of adversity to generate the synthetic images with various levels of one or more adversarial features that are less than or equal to the threshold level of adversity; and generating augmented batches of images comprising images from the training set of images and the synthetic images from the adversarial examples; and training, by the data processing system, the machine learning algorithm using the augmented batches of images to generate the revised machine learning model configured to detect, characterize, classify, or a combination thereof some or all regions or objects within new images without consideration of the adverse regions.

In some embodiments, the training set of images are digital pathology images comprising one or more types of cells.

In some embodiments, the one or more other variables are intensity, chrominance, or both for pixels in each of the images, the one or more regions of interest within the images, the one or more channels of the images, or the one or more fields of view within the images.

In some embodiments, the one or more other variables are a degree of smoothing, a degree of blur, a degree of opacity, a degree of softness, or any combination thereof for pixels in each of the images, the one or more regions of interest within the images, the one or more channels of the images, or the one or more fields of view within the images.

In some embodiments, the one or more other variables are a scaling factor for changing a size of objects depicted in each of the images, the one or more regions of interest within the images, the one or more channels of the images, or the one or more fields of view within the images.

In some embodiments, the one or more adversarial algorithms are configured, for a first channel of the one or more channels of the images, to fix the values of the one or more variables while changing the values of a first variable of the one or more other variables, and for a second channel of the one or more channels of the images, to fix the values of the one or more variables while changing the values of a second variable of the one or more other variables.

In some embodiments, the one or more adversarial algorithms are configured, for a first channel of the one or more channels of the images, to fix the values of a first variable of the one or more variables while changing the values of a first variable of the one or more other variables, and for a second channel of the one or more channels of the images, to fix the values of a second variable of the one or more variables while changing the values of a second variable of the one or more other variables.

In some embodiments, the training comprises performing iterative operations to learn a set of parameters to detect, characterize, classify, or a combination thereof some or all regions or objects within the augmented batches of images that maximizes or minimizes a cost function, wherein each iteration involves finding the set of parameters for the machine learning algorithm so that a value of the cost function using the set of parameters is larger or smaller than a value of the cost function using another set of parameters in a previous iteration, and wherein the cost function is constructed to measure a difference between predictions made for some or all the regions or the objects using the machine learning algorithm and ground truth labels provided for the augmented batches of images.

In some embodiments, the method further comprises: receiving, by the data processing system, a new image; inputting the new image into the machine learning model or the revised machine learning model; detecting, characterizing, classifying, or a combination thereof, by the machine learning model or the revised machine learning model, some or all regions or objects within the new images; and outputting, by the machine learning model or the revised machine learning model, an inference based on the detecting, characterizing, classifying, or a combination thereof.

In some embodiments, a method is provided that includes determining, by a user, a diagnosis of a subject based on a result generated by a machine learning model trained using part or all of one or more techniques disclosed herein and potentially selecting, recommending and/or administering a particular treatment to the subject based on the diagnosis.

In some embodiments, a method is provided that includes determining, by a user, a treatment to select, recommend and/or administer to a subject based on a result generated by a machine learning model trained using part or all of one or more techniques disclosed herein.

In some embodiments, a method is provided that includes determining, by a user, whether a subject is eligible to participate in a clinical study or to assign the subject to a particular cohort in a clinical study based on a result generated by a machine learning model trained using part or all of one or more techniques disclosed herein.

In some embodiments, a system is provided that includes one or more data processors and a non-transitory computer readable storage medium containing instructions which, when executed on the one or more data processors, cause the one or more data processors to perform part or all of one or more methods disclosed herein.

In some embodiments, a computer-program product is provided that is tangibly embodied in a non-transitory machine-readable storage medium and that includes instructions configured to cause one or more data processors to perform part or all of one or more methods disclosed herein.

The terms and expressions which have been employed are used as terms of description and not of limitation, and there is no intention in the use of such terms and expressions of excluding any equivalents of the features shown and described or portions thereof, but it is recognized that various modifications are possible within the scope of the invention claimed. Thus, it should be understood that although the present invention as claimed has been specifically disclosed by embodiments and optional features, modification and variation of the concepts herein disclosed may be resorted to by those skilled in the art, and that such modifications and variations are considered to be within the scope of this invention as defined by the appended claims.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

Aspects and features of the various embodiments will be more apparent by describing examples with reference to the accompanying drawings, in which:

FIG. 1 shows a convolutional neural network model (CNN-VGG16) in a real world scenario incorrectly identifies a banana as a toaster when presented with an adversarial example.

FIG. 2 shows a human breast tissue from two laboratories taken from the Tumor Proliferation Assessment Challenge 2016 (TUPAC16) data set in accordance with various embodiments.

FIGS. 3A-3F show intensity and color variabilities, blur effects, and cell size differences in digital pathology in accordance with various embodiments.

FIG. 4 shows an exemplary network for generating digital pathology images in accordance with various embodiments.

FIG. 5 shows an exemplary computing environment for processing digital pathology images using a machine learning/deep learning model in accordance with various embodiments.

FIG. 6 shows hematoxylin intensity differences for a same subject caused by different staining protocols from two laboratories in accordance with various embodiments.

FIG. 7 shows performance of a deep-learning network is reduced due to small changes in intensity in accordance with various embodiments.

FIG. 8 shows one real and seven synthetic images generated therefrom in accordance with various embodiments.

FIG. 9 shows improved the performance of a deep-learning network with an adversarial trained U-Net model in accordance with various embodiments.

FIGS. 10A and 10B show blur artifacts impact deep-learning network performance in accordance with various embodiments of the disclosure. (A). An example image patch with blurriness on the left side. The dots are cell phenotype classification results. Red, positively stained cells. Black, negatively stained cells. (B). An example image patch pathologists flag as analyzable for >70% of the image, while most of the image is blurry and can be problematic for a deep-learning network such as a classification model.

FIGS. 11A and 11B show quantitative assessment of Ki-67 classification model performance at various blurriness levels in accordance with various embodiments. (A). Example image patches with various levels of blurriness generated by Gaussian kernels of different sigma values. (B). Prediction precision at various blurriness levels for the test dataset. Sigma of Gaussian kernels vary from 0 to 5.

FIGS. 12A and 12B show a comparison of the relative changes in precision for the test dataset between a model trained without blur augmentation and a model trained with blur augmentation in accordance with various embodiments. (A). Relative changes of precision in the tumor positive class. (B). Relative changes of precision of tumor negative class. Train 0: a model trained with no blur augmentation. Train 1.5: a model trained with blur augmentation, where at each epoch each image was blurred by a Gaussian kernel with a sigma value randomly selected between 0 and 1.5.

FIGS. 13A and 13B show an example of poor classification results due to the change of cell sizes in images in accordance with various embodiments.

FIGS. 14A-14C show data argumentation with a variable cell size experiment protocol in accordance with various embodiments.

FIG. 15 shows a flowchart illustrating a process for training a machine learning algorithm in accordance with various embodiments of the disclosure.

FIG. 16 shows a flowchart illustrating a process for training and using a machine learning model in accordance with various embodiments of the disclosure.

### DETAILED DESCRIPTION

While certain embodiments are described, these embodiments are presented by way of example only, and are not intended to limit the scope of protection. The apparatuses, methods, and systems described herein may be embodied in a variety of other forms. Furthermore, various omissions, substitutions, and changes in the form of the example methods and systems described herein may be made without departing from the scope of protection.

### I. Overview

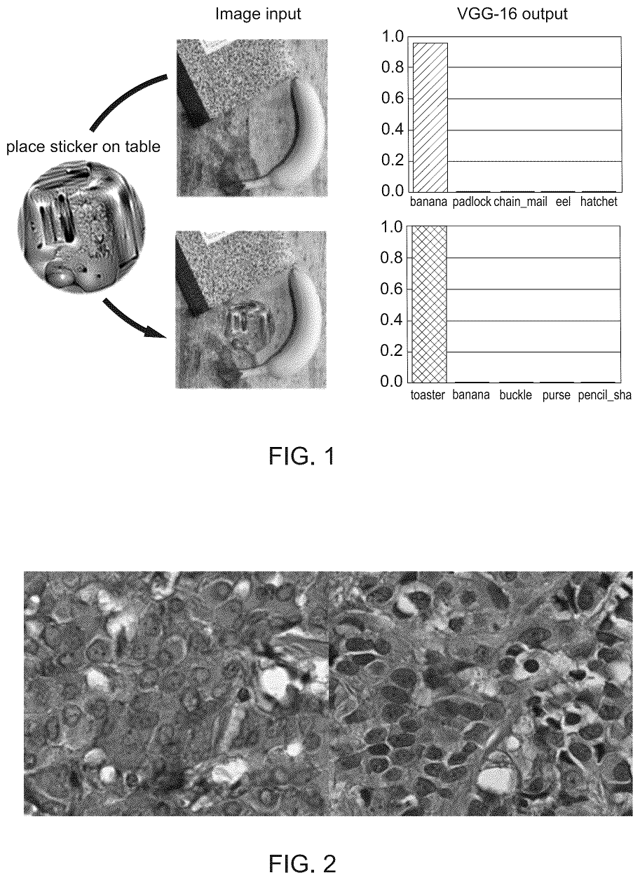

Machine learning models, including those comprised of deep learning and artificial intelligence networks, can make mistakes when attempting to detect, characterize and/or classify part or all of a digital pathology image. In particular, machine learning models are broadly vulnerable to adversarial machine learning. Adversarial machine learning is a machine learning technique that intentionally or unintentionally tricks machine learning models by providing deceptive input known as adversarial examples. For example, when a photo of a tabletop with a banana and a notebook (top photograph shown in FIG. 1) is passed through a convolutional neural network model such as VGG16, the network reports class ‘banana’ with 97% confidence (top plot). However, if a sticker targeted to the class “toaster” is placed on the table (bottom photograph), the photograph is classified as a toaster with 99% confidence (bottom plot, FIG. 1). The sticker is a perceivable perturbation in the image that causes the VGG16 to misclassify the object in the image with a high confidence. Although this is a perceptible adversarial example, it should be understood that imperceptible adversarial examples also exist that could cause similar misclassifications. The existence of the perceptible (or imperceptible) adversarial example reveals the limited generalization ability of the VGG16.

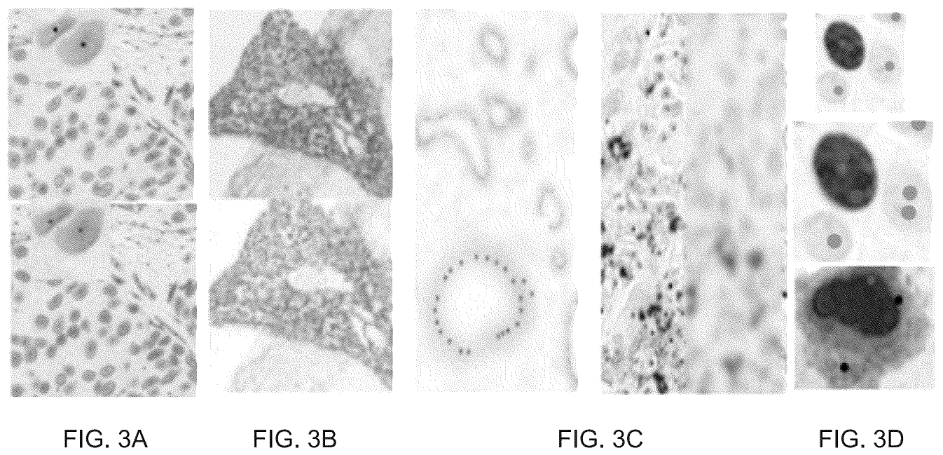

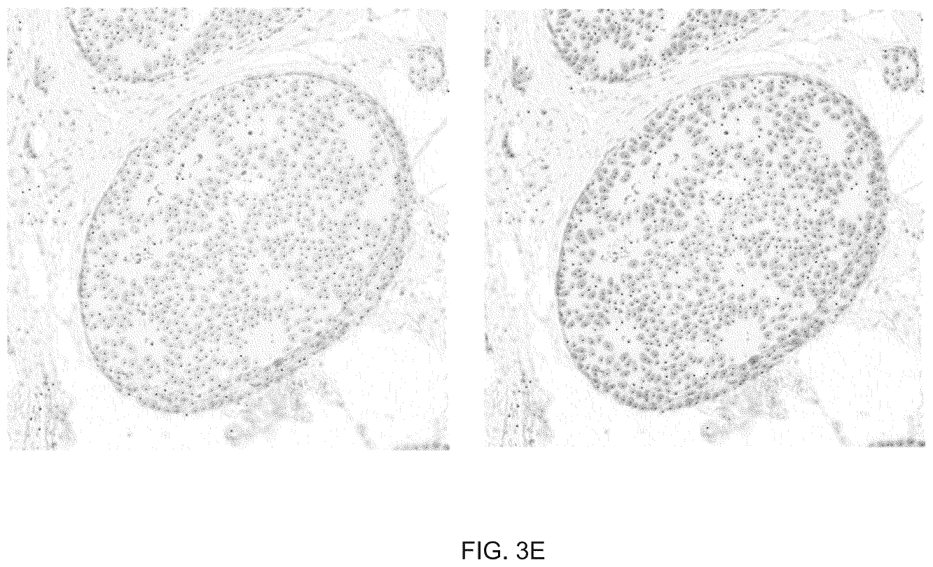

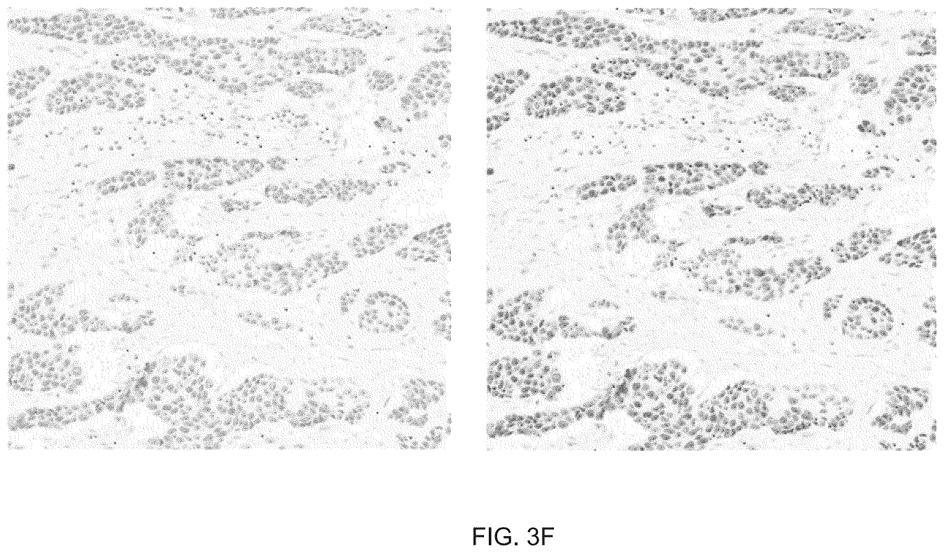

In digital pathology, in addition to the aforementioned adversarial perturbations, domain-specific perturbations and variances from tissue collection, tissue slide preparation, and digital image acquisition and processing can unintentionally or intentionally act as adversarial examples causing adversarial machine learning. The perturbations and variances may include intensity differences and color variability caused by inter-scanner and inter-laboratory variability (e.g., hardware and/or software differences may cause variation in digital image acquisition between scanners; whereas environmental and/or protocol differences may cause variation in slide preparation at different clinical/research laboratories). FIG. 2 shows two different images captured by two scanners from different laboratories. The differences of color and intensity are due to differences in tissue treatment, such as concentrations of chemical stains or the staining protocol. FIGS. 3A and 3B show the intensity changes due to staining protocol variances and color differences (the scanned raw data and the corrected image displayed on the monitor). FIGS. 3E and 3F show the deep learning network incorrectly identified a high number of ER and PR positive as negative because of the intensity changes (ER-positive: Breast cancers that have estrogen receptors are called ER-positive (or ER+) cancers; whereas PR-positive: Breast cancers with progesterone receptors are called PR-positive (or PR+) cancers).

The perturbations and variances may further include gradient changes and blur effects (shown in FIG. 3C) caused by poor scanning quality. These gradient changes and blur effects may cause machine learning, deep learning, and artificial intelligence networks to perform poorly (e.g., either positive cells cannot be identified, or no cells can be detected).

The perturbations and variances may further include assay staining artifacts (e.g., background wash) and variances in cell size (e.g., different tissues/patients may exhibit different cell sizes such as different tumor cell sizes). FIG. 3D shows enlarged cells with a ki67 marker. When the cell sizes are enlarged, the machine learning, deep learning, and artificial intelligence networks may incorrectly detect cells. In addition, cell type may also affect the size of cells. For examples, in tumor cells, one of the hallmarks of cancer is pleomorphism, i.e., variation in cell size and shape. Within a single tumor individual cells may vary widely in size and shape. Between different tumors, there can also be a very wide range of size differences due to differences in the type of tumor and tumor grade. Some tumors were even named according to their appearance, for example, “small cell carcinoma” versus “large cell undifferentiated carcinoma”, or even “giant cell tumors”, which can have enormous cells. Therefore, the cell size will vary within one patient's tumor and between different patients. For normal cells, there should be much less variation in cell size amongst normal cells of the same type and stage, for example, peripheral B lymphocytes should be pretty uniform in shape in a patient and between patients, especially in vivo.

However, in histologic preparations there may be some variations introduced by tissue processing. For example, fixation can cause cell shrinkage. The different staining steps of Hematoxylin and Eosin (H&E), immunohistochemistry (IHC) and in situ hybridization (ISH) also may introduces changes in the final stained images. H&E staining usually preserves tissue morphology well, while IHC staining includes added steps, such as cell conditioning and protease treatments, which can alter tissue morphology. ISH is the most aggressive with lots of cell conditioning, heating and protease treatment, which can significantly change the morphology of cells. With ISH, the normal lymphocytes often look enlarged and atypical. These perturbations and variances can negatively affect the quality and reliability of machine learning, deep learning and artificial intelligence networks. It is thus important to solve these challenges and improve the performance of deep learning and artificial intelligence networks.

To address these challenges and others, various embodiments disclosed herein are directed to methods, systems, and computer readable storage media for pre-processing training data, augmenting training data, and using synthetic training data to effectively train a machine learning model to (i) reject adversarial example images, and (ii) detect, characterize and/or classify some or all regions of accepted images that do not include adversarial example regions. In particular, the various embodiments leverage synthetically generated adversarial examples to improve robustness of machine learning models. The synthetically generated adversarial examples are leveraged in two processes: (i) augment training data so that they comprise “real” image examples with adversarial images examples (synthetic images with artificially created perturbations or variances) and train the machine learning models with the augmented training data, and (ii) label training data based on adversarial example experiments and train the machine learning models with the training data to identify images or regions that include perturbations or variance that will adversely affect the models inference/prediction ability (e.g., classification) and either reject the image outright as an adversarial example or exclude the adversarial region(s) from downstream analysis (e.g., segment, classify, and mask as region(s) not to be considered in subsequent analysis). These processes can be performed individually or in combination to improve robustness of the machine-learning models. Further, these processes can be performed individually or in combination for a single type of perturbation or variation (e.g., intensity) or for combinations of types of perturbations and variations (e.g., intensity and blurriness).

In one illustrative embodiment, a computer-implemented process is provided that includes receiving, at a data processing system, a training set of images for training a machine learning algorithm to detect, characterize, classify, or a combination thereof some or all regions or objects within the images; augmenting, by the data processing system, the training set of images with adversarial examples, wherein the augmenting comprises: inputting the training set of images into one or more adversarial algorithms, applying the one or more adversarial algorithms to the training set of images in order to generate synthetic images as the adversarial examples, wherein the one or more adversarial algorithms are configured, for each of the images, one or more regions of interest within the images, one or more channels of the images, or one or more fields of view within the images, to fix values of one or more variables while changing the values of one or more other variables to generate the synthetic images with various levels of one or more adversarial features, and generating augmented batches of images comprising images from the training set of images and the synthetic images from the adversarial examples; and training, by the data processing system, the machine learning algorithm using the augmented batches of images to generate a machine learning model configured to detect, characterize, classify, or a combination thereof some or all regions or objects within new images.

In another illustrative embodiment, a computer-implemented process is provided that includes obtaining, by a data processing system, a set of digital pathology images comprising one or more types of cells; inputting, by the data processing system, the set of digital pathology images into one or more adversarial algorithms; applying, by the data processing system, the one or more adversarial algorithms to the set of digital pathology images in order to generate synthetic images, wherein the one or more adversarial algorithms are configured, for each of the images, one or more regions of interest within the images, one or more channels of the images, or one or more fields of view within the images, to fix values of one or more variables while changing the values of one or more other variables to generate the synthetic images with various levels of one or more adversarial features; evaluating, by the data processing system, performance of a machine learning model to make an inference with respect to some or all regions or objects within the set of digital pathology images and the synthetic images; identifying, by the data processing system, a threshold level of adversity at which the machine learning model can no longer accurately make the inference based on the evaluating; applying, by the data processing system, a range of adversity above the identified threshold level as a ground-truth label in a training set of images; and training, by the data processing system, a machine learning algorithm using the training set of images to generate a revised machine learning model configured to identify adverse regions and exclude the adverse regions from downstream processing or analysis.

Advantageously, the various techniques described herein can improve robustness of the machine learning models (e.g., improve accuracy in cell classification).

### II. Definitions

As used herein, when an action is “based on” something, this means the action is based at least in part on at least a part of the something.

As used herein, the terms “substantially,” “approximately,” and “about” are defined as being largely but not necessarily wholly what is specified (and include wholly what is specified) as understood by one of ordinary skill in the art. In any disclosed embodiment, the term “substantially,” “approximately,” or “about” may be substituted with “within [a percentage] of” what is specified, where the percentage includes 0.1, 1, 5, and 10 percent.

As used herein, the term “sample,” “biological sample,” “tissue,” or “tissue sample” refers to any sample including a biomolecule (such as a protein, a peptide, a nucleic acid, a lipid, a carbohydrate, or a combination thereof) that is obtained from any organism including viruses. Other examples of organisms include mammals (such as humans; veterinary animals like cats, dogs, horses, cattle, and swine; and laboratory animals like mice, rats and primates), insects, annelids, arachnids, marsupials, reptiles, amphibians, bacteria, and fungi. Biological samples include tissue samples (such as tissue sections and needle biopsies of tissue), cell samples (such as cytological smears such as Pap smears or blood smears or samples of cells obtained by microdissection), or cell fractions, fragments or organelles (such as obtained by lysing cells and separating their components by centrifugation or otherwise). Other examples of biological samples include blood, serum, urine, semen, fecal matter, cerebrospinal fluid, interstitial fluid, mucous, tears, sweat, pus, biopsied tissue (for example, obtained by a surgical biopsy or a needle biopsy), nipple aspirates, cerumen, milk, vaginal fluid, saliva, swabs (such as buccal swabs), or any material containing biomolecules that is derived from a first biological sample. In certain embodiments, the term “biological sample” as used herein refers to a sample (such as a homogenized or liquefied sample) prepared from a tumor or a portion thereof obtained from a subject.

As used herein, the term “biological material,” “biological structure,” or “cell structure” refers to natural materials or structures that comprise a whole or a part of a living structure (e.g., a cell nucleus, a cell membrane, cytoplasm, a chromosome, DNA, a cell, a cluster of cells, or the like).

As used herein, a “digital pathology image” refers to a digital image of a stained sample.

As used herein, the term “cell detection” refers to detection of the pixel locations and characteristics of a cell or a cell structure (e.g., a cell nucleus, a cell membrane, cytoplasm, a chromosome, DNA, a cell, a cluster of cells, or the like).

As used herein, the term “target region” refers to a region of an image including image data that is intended be assessed in an image analysis process. Target regions include any region such as tissue regions of an image that is intended to be analyzed in the image analysis process (e.g., tumor cells or staining expressions).

As used herein, the term “tile” or “tile image” refers to a single image corresponding to a portion of a whole image, or a whole slide. In some embodiments, “tile” or “tile image” refers to a region of a whole slide scan or an area of interest having (x,y) pixel dimensions (e.g., 1000 pixels by 1000 pixels). For example, consider a whole image split into M columns of tiles and N rows of tiles, where each tile within the M×N mosaic comprises a portion of the whole image, i.e. a tile at location M₁, N₁ comprises a first portion of an image, while a tile at location M₁, N₂ comprises a second portion of the image, the first and second portions being different. In some embodiments, the tiles may each have the same dimensions (pixel size by pixel size). In some instances, tiles can overlap partially, representing overlapping regions of a whole slide scan or an area of interest.

As used herein, the term “patch,” “image patch,” or “mask patch” refers to a container of pixels corresponding to a portion of a whole image, a whole slide, or a whole mask. In some embodiments, “patch,” “image patch,” or “mask patch” refers to a region of an image or a mask, or an area of interest having (x, y) pixel dimensions (e.g., 256 pixels by 256 pixels). For example, an image of 1000 pixels by 1000 pixels divided into 100 pixel×100 pixel patches would comprise 10 patches (each patch containing 1000 pixels). In other embodiments, the patches overlap with each “patch,” “image patch,” or “mask patch” having (x, y) pixel dimensions and sharing one or more pixels with another “patch,” “image patch,” or “mask patch.”

### III. Generation of Digital Pathology Images

Digital pathology involves the interpretation of digitized images in order to correctly diagnose subjects and guide therapeutic decision making. In digital pathology solutions, image-analysis workflows can be established to automatically detect or classify biological objects of interest e.g., positive, negative tumor cells, etc. An exemplary digital pathology solution workflow includes obtaining tissue slides, scanning preselected areas or the entirety of the tissue slides with a digital image scanner (e.g., a whole slide image (WSI) scanner) to obtain digital images, performing image analysis on the digital image using one or more image analysis algorithms, and potentially detecting, quantifying (e.g., counting or identify object-specific or cumulative areas of) each object of interest based on the image analysis (e.g., quantitative or semi-quantitative scoring such as positive, negative, medium, weak, etc.).

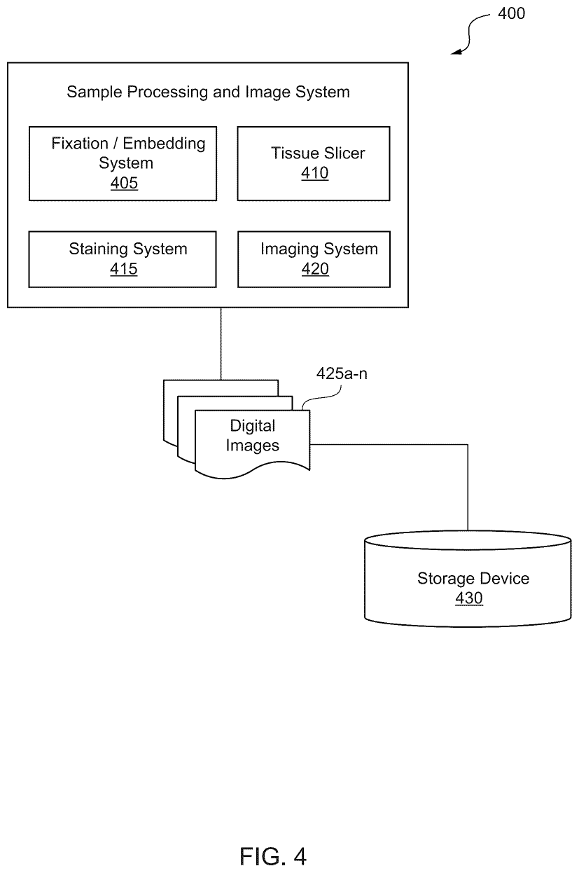

FIG. 4 shows an exemplary network 400 for generating digital pathology images. A fixation/embedding system 405 fixes and/or embeds a tissue sample (e.g., a sample including at least part of at least one tumor) using a fixation agent (e.g., a liquid fixing agent, such as a formaldehyde solution) and/or an embedding substance (e.g., a histological wax, such as a paraffin wax and/or one or more resins, such as styrene or polyethylene). Each sample may be fixed by exposing the sample to a fixating agent for a predefined period of time (e.g., at least 3 hours) and by then dehydrating the sample (e.g., via exposure to an ethanol solution and/or a clearing intermediate agent). The embedding substance can infiltrate the sample when it is in liquid state (e.g., when heated).

Sample fixation and/or embedding is used to preserve the sample and slow down sample degradation. In histology, fixation generally refers to an irreversible process of using chemicals to retain the chemical composition, preserve the natural sample structure, and maintain the cell structure from degradation. Fixation may also harden the cells or tissues for sectioning. Fixatives may enhance the preservation of samples and cells using cross-linking proteins. The fixatives may bind to and cross-link some proteins, and denature other proteins through dehydration, which may harden the tissue and inactivate enzymes that might otherwise degrade the sample. The fixatives may also kill bacteria.

The fixatives may be administered, for example, through perfusion and immersion of the prepared sample. Various fixatives may be used, including methanol, a Bouin fixative and/or a formaldehyde fixative, such as neutral buffered formalin (NBF) or paraffin-formalin (paraformaldehyde-PFA). In cases where a sample is a liquid sample (e.g., a blood sample), the sample may be smeared onto a slide and dried prior to fixation. While the fixing process may serve to preserve the structure of the samples and cells for the purpose of histological studies, the fixation may result in concealing of tissue antigens thereby decreasing antigen detection. Thus, the fixation is generally considered as a limiting factor for immunohistochemistry because formalin can cross-link antigens and mask epitopes. In some instances, an additional process is performed to reverse the effects of cross-linking, including treating the fixed sample with citraconic anhydride (a reversible protein cross-linking agent) and heating.

Embedding may include infiltrating a sample (e.g., a fixed tissue sample) with a suitable histological wax, such as paraffin wax. The histological wax may be insoluble in water or alcohol, but may be soluble in a paraffin solvent, such as xylene. Therefore, the water in the tissue may need to be replaced with xylene. To do so, the sample may be dehydrated first by gradually replacing water in the sample with alcohol, which can be achieved by passing the tissue through increasing concentrations of ethyl alcohol (e.g., from 0 to about 100%). After the water is replaced by alcohol, the alcohol may be replaced with xylene, which is miscible with alcohol. Because the histological wax may be soluble in xylene, the melted wax may fill the space that is filled with xylene and was filled with water before. The wax filled sample may be cooled down to form a hardened block that can be clamped into a microtome, vibratome, or compresstome for section cutting. In some cases, deviation from the above example procedure may result in an infiltration of paraffin wax that leads to inhibition of the penetration of antibody, chemical, or other fixatives.

A tissue slicer 410 may then be used for sectioning the fixed and/or embedded tissue sample (e.g., a sample of a tumor). Sectioning is the process of cutting thin slices (e.g., a thickness of, for example, 4-5 m) of a sample from a tissue block for the purpose of mounting it on a microscope slide for examination. Sectioning may be performed using a microtome, vibratome, or compresstome. In some cases, tissue can be frozen rapidly in dry ice or Isopentane, and can then be cut in a refrigerated cabinet (e.g., a cryostat) with a cold knife. Other types of cooling agents can be used to freeze the tissues, such as liquid nitrogen. The sections for use with brightfield and fluorescence microscopy are generally on the order of 4-m thick. In some cases, sections can be embedded in an epoxy or acrylic resin, which may enable thinner sections (e.g., <2 μm) to be cut. The sections may then be mounted on one or more glass slides. A coverslip may be placed on top to protect the sample section.

Because the tissue sections and the cells within them are virtually transparent, preparation of the slides typically further includes staining (e.g., automatically staining) the tissue sections in order to render relevant structures more visible. In some instances, the staining is performed manually. In some instances, the staining is performed semi-automatically or automatically using a staining system 415. The staining process includes exposing sections of tissue samples or of fixed liquid samples to one or more different stains (e.g., consecutively or concurrently) to express different characteristics of the tissue.

For example, staining may be used to mark particular types of cells and/or to flag particular types of nucleic acids and/or proteins to aid in the microscopic examination. The staining process generally involves adding a dye or stain to a sample to qualify or quantify the presence of a specific compound, a structure, a molecule, or a feature (e.g., a subcellular feature). For example, stains can help to identify or highlight specific biomarkers from a tissue section. In other example, stains can be used to identify or highlight biological tissues (e.g., muscle fibers or connective tissue), cell populations (e.g., different blood cells), or organelles within individual cells.

One exemplary type of tissue staining is histochemical staining, which uses one or more chemical dyes (e.g., acidic dyes, basic dyes, chromogens) to stain tissue structures. Histochemical staining may be used to indicate general aspects of tissue morphology and/or cell microanatomy (e.g., to distinguish cell nuclei from cytoplasm, to indicate lipid droplets, etc.). One example of a histochemical stain is H&E. Other examples of histochemical stains include trichrome stains (e.g., Masson's Trichrome), Periodic Acid-Schiff (PAS), silver stains, and iron stains. The molecular weight of a histochemical staining reagent (e.g., dye) is typically about 500 kilodaltons (kD) or less, although some histochemical staining reagents (e.g., Alcian Blue, phosphomolybdic acid (PMA)) may have molecular weights of up to two or three thousand kD. One case of a high-molecular-weight histochemical staining reagent is alpha-amylase (about 55 kD), which may be used to indicate glycogen.

Another type of tissue staining is IHC, also called “immunostaining”, which uses a primary antibody that binds specifically to the target antigen of interest (also called a biomarker). IHC may be direct or indirect. In direct IHC, the primary antibody is directly conjugated to a label (e.g., a chromophore or fluorophore). In indirect IHC, the primary antibody is first bound to the target antigen, and then a secondary antibody that is conjugated with a label (e.g., a chromophore or fluorophore) is bound to the primary antibody. The molecular weights of IHC reagents are much higher than those of histochemical staining reagents, as the antibodies have molecular weights of about 150 kD or more.

Various types of staining protocols may be used to perform the staining. For example, an exemplary IHC staining protocol includes using a hydrophobic barrier line around the sample (e.g., tissue section) to prevent leakage of reagents from the slide during incubation, treating the tissue section with reagents to block endogenous sources of nonspecific staining (e.g., enzymes, free aldehyde groups, immunoglobins, other irrelevant molecules that can mimic specific staining), incubating the sample with a permeabilization buffer to facilitate penetration of antibodies and other staining reagents into the tissue, incubating the tissue section with a primary antibody for a period of time (e.g., 1-24 hours) at a particular temperature (e.g., room temperature, 6-8° C.), rinsing the sample using wash buffer, incubating the sample (tissue section) with a secondary antibody for another period of time at another particular temperature (e.g., room temperature), rinsing the sample again using water buffer, incubating the rinsed sample with a chromogen (e.g., DAB: 3,3′-diaminobenzidine), and washing away the chromogen to stop the reaction. In some instances, counterstaining is subsequently used to identify an entire “landscape” of the sample and serve as a reference for the main color used for the detection of tissue targets. Examples of the counterstains may include hematoxylin (stains from blue to violet), Methylene blue (stains blue), toluidine blue (stains nuclei deep blue and polysaccharides pink to red), nuclear fast red (also called Kernechtrot dye, stains red), and methyl green (stains green); non-nuclear chromogenic stains, such as eosin (stains pink), etc. A person of ordinary skill in the art will recognize that other immunohistochemistry staining techniques can be implemented to perform staining.

In another example, an H&E staining protocol can be performed for the tissue section staining. The H&E staining protocol includes applying hematoxylin stain mixed with a metallic salt, or mordant to the sample. The sample can then be rinsed in a weak acid solution to remove excess staining (differentiation), followed by bluing in mildly alkaline water. After the application of hematoxylin, the sample can be counterstained with eosin. It will be appreciated that other H&E staining techniques can be implemented.

In some embodiments, various types of stains can be used to perform staining, depending on which features of interest is targeted. For example, DAB can be used for various tissue sections for the IHC staining, in which the DAB results a brown color depicting a feature of interest in the stained image. In another example, alkaline phosphatase (AP) can be used for skin tissue sections for the IHC staining, since DAB color may be masked by melanin pigments. With respect to primary staining techniques, the applicable stains may include, for example, basophilic and acidophilic stains, hematin and hematoxylin, silver nitrate, trichrome stains, and the like. Acidic dyes may react with cationic or basic components in tissues or cells, such as proteins and other components in the cytoplasm. Basic dyes may react with anionic or acidic components in tissues or cells, such as nucleic acids. As noted above, one example of a staining system is H&E. Eosin may be a negatively charged pink acidic dye, and hematoxylin may be a purple or blue basic dye that includes hematein and aluminum ions. Other examples of stains may include periodic acid-Schiff reaction (PAS) stains, Masson's trichrome, Alcian blue, van Gieson, Reticulin stain, and the like. In some embodiments, different types of stains may be used in combination.

The sections may then be mounted on corresponding slides, which an imaging system 420 can then scan or image to generate raw digital-pathology images 425a-n. A microscope (e.g., an electron or optical microscope) can be used to magnify the stained sample. For example, optical microscopes may have a resolution less than 1 μm, such as about a few hundred nanometers. To observe finer details in nanometer or sub-nanometer ranges, electron microscopes may be used. An imaging device (combined with the microscope or separate from the microscope) images the magnified biological sample to obtain the image data, such as a multi-channel image (e.g., a multi-channel fluorescent) with several (such as between ten to sixteen, for example) channels. The imaging device may include, without limitation, a camera (e.g., an analog camera, a digital camera, etc.), optics (e.g., one or more lenses, sensor focus lens groups, microscope objectives, etc.), imaging sensors (e.g., a charge-coupled device (CCD), a complimentary metal-oxide semiconductor (CMOS) image sensor, or the like), photographic film, or the like. In digital embodiments, the imaging device can include a plurality of lenses that cooperate to prove on-the-fly focusing. An image sensor, for example, a CCD sensor can capture a digital image of the biological sample. In some embodiments, the imaging device is a brightfield imaging system, a multispectral imaging (MSI) system or a fluorescent microscopy system. The imaging device may utilize nonvisible electromagnetic radiation (UV light, for example) or other imaging techniques to capture the image. For example, the imaging device may comprise a microscope and a camera arranged to capture images magnified by the microscope. The image data received by the analysis system may be identical to and/or derived from raw image data captured by the imaging device.

The images of the stained sections may then be stored in a storage device 425 such as a server. The images may be stored locally, remotely, and/or in a cloud server. Each image may be stored in association with an identifier of a subject and a date (e.g., a date when a sample was collected and/or a date when the image was captured). An image may further be transmitted to another system (e.g., a system associated with a pathologist, an automated or semi-automated image analysis system, or a machine learning training and deployment system, as described in further detail herein).

It will be appreciated that modifications to processes described with respect to network 400 are contemplated. For example, if a sample is a liquid sample, embedding and/or sectioning may be omitted from the process.

### IV. Exemplary System for Digital Pathology Image Transformation

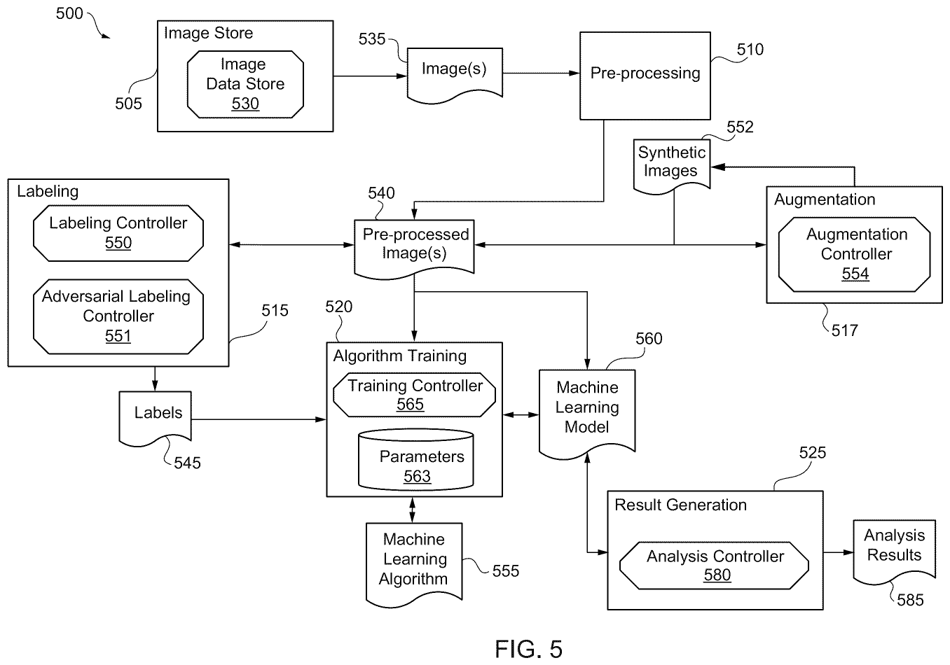

FIG. 5 shows a block diagram that illustrates a computing environment 500 for processing digital pathology images using a machine learning model. As further described herein, processing a digital pathology image can include using the digital pathology image to train a machine learning algorithm and/or transforming part or all of the digital pathology image into one or more results using a trained (or partly trained) version of the machine learning algorithm (i.e., a machine learning model).

As shown in FIG. 5, computing environment 500 includes several stages: an image store stage 505, a pre-processing stage 510, a labeling stage 515, a data augmentation stage 517, a training stage 520, and a result generation stage 525.

The image store stage 505 includes one or more image data stores 530 (e.g., storage device 430 described with respect to FIG. 4) that are accessed (e.g., by pre-processing stage 510) to provide a set of digital images 535 of preselected areas from or the entirety of the biological sample slides (e.g., tissue slides). Each digital image 535 stored in each image data store 530 and accessed at image store stage 510 may include a digital pathology image generated in accordance with part or all of processes described with respect to network 400 depicted in FIG. 4. In some embodiments, each digital image 535 includes image data from one or more scanned slides. Each of the digital images 535 may correspond to image data from a single specimen and/or a single day on which the underlying image data corresponding to the image was collected.

The image data may include an image, as well as any information related to color channels or color wavelength channels, as well as details regarding the imaging platform on which the image was generated. For instance, a tissue section may need to be stained by means of application of a staining assay containing one or more different biomarkers associated with chromogenic stains for brightfield imaging or fluorophores for fluorescence imaging. Staining assays can use chromogenic stains for brightfield imaging, organic fluorophores, quantum dots, or organic fluorophores together with quantum dots for fluorescence imaging, or any other combination of stains, biomarkers, and viewing or imaging devices. Example biomarkers include biomarkers for estrogen receptors (ER), human epidermal growth factor receptors 2 (HER2), human Ki-67 protein, progesterone receptors (PR), programmed cell death protein 1 (PD1), and the like, where the tissue section is detectably labeled with binders (e.g., antibodies) for each of ER, HER2, Ki-67, PR, PD1, etc. In some embodiments, digital image and data analysis operations such as classifying, scoring, cox modeling, and risk stratification are dependent upon the type of biomarker being used as well as the field-of-view (FOV) selection and annotations. Moreover, a typical tissue section is processed in an automated staining/assay platform that applies a staining assay to the tissue section, resulting in a stained sample. There are a variety of commercial products on the market suitable for use as the staining/assay platform, one example being the VENTANA® SYMPHONY® product of the assignee Ventana Medical Systems, Inc. Stained tissue sections may be supplied to an imaging system, for example on a microscope or a whole-slide scanner having a microscope and/or imaging components, one example being the VENTANA® iScan Coreo®/VENTANA® DP200 product of the assignee Ventana Medical Systems, Inc. Multiplex tissue slides may be scanned on an equivalent multiplexed slide scanner system. Additional information provided by the imaging system may include any information related to the staining platform, including a concentration of chemicals used in staining, a reaction times for chemicals applied to the tissue in staining, and/or pre-analytic conditions of the tissue, such as a tissue age, a fixation method, a duration, how the section was embedded, cut, etc.

At the pre-processing stage 510, each of one, more, or all of the set of digital images 535 are pre-processed using one or more techniques to generate a corresponding pre-processed image 540. The pre-processing may comprise cropping the images. In some instances, the pre-processing may further comprise standardization or rescaling (e.g., normalization) to put all features on a same scale (e.g., a same size scale or a same color scale or color saturation scale). In certain instances, the images are resized with a minimum size (width or height) of predetermined pixels (e.g., 2500 pixels) or with a maximum size (width or height) of predetermined pixels (e.g., 3000 pixels) and optionally kept with the original aspect ratio. The pre-processing may further comprise removing noise. For example, the images may be smoothed to remove unwanted noise such as by applying a Gaussian function or Gaussian blur.

The pre-processed images 540 may include one or more training images, validation images, and unlabeled images. It should be appreciated that the pre-processed images 540 corresponding to the training, validation and unlabeled groups need not be accessed at a same time. For example, an initial set of training and validation pre-processed images 540 may first be accessed and used to train a machine learning algorithm 555, and unlabeled input images may be subsequently accessed or received (e.g., at a single or multiple subsequent times) and used by a trained machine learning model 560 to provide desired output (e.g., cell classification).

In some instances, the machine learning algorithms 555 are trained using supervised training, and some or all of the pre-processed images 540 are partly or fully labeled manually, semi-automatically, or automatically at labeling stage 515 with labels 545 that identify a “correct” interpretation (i.e., the “ground-truth”) of various biological material and structures within the pre-processed images 540. For example, the label 545 may identify a feature of interest (for example) a classification of a cell, a binary indication as to whether a given cell is a particular type of cell, a binary indication as to whether the pre-processed image 540 (or a particular region with the pre-processed image 540) includes a particular type of depiction (e.g., necrosis or an artifact), a categorical characterization of a slide-level or region-specific depiction (e.g., that identifies a specific type of cell), a number (e.g., that identifies a quantity of a particular type of cells within a region, a quantity of depicted artifacts, or a quantity of necrosis regions), presence or absence of one or more biomarkers, etc. In some instances, a label 545 includes a location. For example, a label 545 may identify a point location of a nucleus of a cell of a particular type or a point location of a cell of a particular type (e.g., raw dot labels). As another example, a label 545 may include a border or boundary, such as a border of a depicted tumor, blood vessel, necrotic region, etc. As another example, a label 545 may include one or more biomarkers identified based on biomarker patterns observed using one or more stains. For example, a tissue slide stained for a biomarker, e.g., programmed cell death protein 1 (“PD1”), may be observed and/or processed in order to label cells as either positive cells or negative cells in view of expression levels and patterns of PD1 in the tissue. Depending on a feature of interest, a given labeled pre-processed image 540 may be associated with a single label 545 or multiple labels 545. In the latter case, each label 545 may be associated with (for example) an indication as to which position or portion within the pre-processed image 545 the label corresponds.

A label 545 assigned at labeling stage 515 may be identified based on input from a human user (e.g., pathologist or image scientist) and/or an algorithm (e.g., an annotation tool) configured to define a label 545. In some instances, labeling stage 515 can include transmitting and/or presenting part or all of one or more pre-processed images 540 to a computing device operated by the user. In some instances, labeling stage 515 includes availing an interface (e.g., using an API) to be presented by labeling controller 550 at the computing device operated by the user, where the interface includes an input component to accept input that identifies labels 545 for features of interest. For example, a user interface may be provided by the labeling controller 550 that enables selection of an image or region of an image (e.g., FOV) for labeling. A user operating the terminal may select an image or FOV using the user interface. Several image or FOV selection mechanisms may be provided, such as designating known or irregular shapes, or defining an anatomic region of interest (e.g., tumor region). In one example, the image or FOV is a whole-tumor region selected on an IHC slide stained with an H&E stain combination. The image or FOV selection may be performed by a user or by automated image-analysis algorithms, such as tumor region segmentation on an H&E tissue slide, etc. For example, a user may select that the image or FOV as the whole slide or the whole tumor, or the whole slide or whole tumor region may be automatically designated as the image or FOV using a segmentation algorithm. Thereafter, the user operating the terminal may select one or more labels 545 to be applied to the selected image or FOV such as point location on a cell, a positive marker for a biomarker expressed by a cell, a negative biomarker for a biomarker not expressed by a cell, a boundary around a cell, and the like.

In some instances, the interface may identify which and/or a degree to which particular label(s) 545 are being requested, which may be conveyed via (for example) text instructions and/or a visualization to the user. For example, a particular color, size and/or symbol may represent that a label 545 is being requested for a particular depiction (e.g., a particular cell or region or staining pattern) within the image relative to other depictions. If labels 545 corresponding to multiple depictions are to be requested, the interface may concurrently identify each of the depictions or may identify each depiction sequentially (such that provision of a label for one identified depiction triggers an identification of a next depiction for labeling). In some instances, each image is presented until the user has identified a specific number of labels 545 (e.g., of a particular type). For example, a given whole-slide image or a given patch of a whole-slide image may be presented until the user has identified the presence or absence of three different biomarkers, at which point the interface may present an image of a different whole-slide image or different patch (e.g., until a threshold number of images or patches are labeled). Thus, in some instances, the interface is configured to request and/or accept labels 545 for an incomplete subset of features of interest, and the user may determine which of potentially many depictions will be labeled.

In some instances, labeling stage 515 includes labeling controller 550 implementing an annotation algorithm in order to semi-automatically or automatically label various features of an image or a region of interest within the image. The labeling controller 550 annotates the image or FOV on a first slide in accordance with the input from the user or the annotation algorithm and maps the annotations across a remainder of the slides. Several methods for annotation and registration are possible, depending on the defined FOV. For example, a whole tumor region annotated on a H&E slide from among the plurality of serial slides may be selected automatically or by a user on an interface such as VIRTUOSO/VERSO™ or similar. Since the other tissue slides correspond to serial sections from the same tissue block, the labeling controller 550 executes an inter-marker registration operation to map and transfer the whole tumor annotations from the H&E slide to each of the remaining IHC slides in a series. Exemplary methods for inter-marker registration are described in further detail in commonly-assigned and international application WO2014140070A2, “Whole slide image registration and cross-image annotation devices, systems and methods”, filed Mar. 12, 2014, which is hereby incorporated by reference in its entirety for all purposes. In some embodiments, any other method for image registration and generating whole-tumor annotations may be used. For example, a qualified reader such as a pathologist may annotate a whole-tumor region on any other IHC slide, and execute the labeling controller 550 to map the whole tumor annotations on the other digitized slides. For example, a pathologist (or automatic detection algorithm) may annotate a whole-tumor region on an H&E slide triggering an analysis of all adjacent serial sectioned IHC slides to determine whole-slide tumor scores for the annotated regions on all slides.

In some instances, labeling stage 515 further includes adversarial labeling controller 551 implementing an annotation algorithm in order to semi-automatically or automatically identify and label various adversarial features of an image or a region of interest within the image. The adversarial labeling controller 550 identifies a level of adversity at which a machine learning model can no longer accurately make an inference, and determines how to set-up ground-truth labels for the adversarial features in an unbiased manner. More specifically, the augmentation control 554 take as input one or more original images (e.g., images from a training set of images of the pre-processed images 540) and generates synthetic images 552 with various levels of adversarial features such as out-of-focus artifacts, as discussed in further detail herein. The adversarial labeling controller 550 then uses the original images and the synthetic images to evaluate machine learning model performance. For evaluation of the machine learning model, adversarial labeling controller 550 quantitatively assesses performance changes of the machine learning model at the different levels of adversarial features, identifies a threshold level of adversity at which the machine learning model can no longer accurately make an inference (e.g., performance degradation beyond a given tolerance), and then applies a range of adversity (e.g., blurriness) above the identified threshold level as a ground-truth label in a set of training images to train a machine learning model to identify adverse regions and exclude the adverse regions from downstream processing/analysis.

Additionally or alternatively, the adversarial labeling controller 550 may use the threshold level of adversity as a filter to outright reject images (e.g., training, validation, unlabeled, etc. from the pre-processed images 540) having a range of adversity (e.g., blurriness) above the threshold level prior to using the images for training and/or result generation. Additionally, or alternatively, in order to build a machine learning model robust against low to medium levels of adversity below the threshold level, an adversarial robustness training strategy can be implemented that enforces the machine learning model to learn discriminative image features independent of the adversarial features. Specifically, a data augmentation approach may be implemented for model training that includes generating and incorporating synthetic images with various low to medium ranges of adversity into a set of training images for use in training a machine learning model. It should be understood that the threshold level may change over time as the machine learning model learns to better interpret adversarial images, and thus the threshold level may be updated using a similar approach of evaluation as discussed herein.

At augmentation stage 517, training sets of images (original images) that are labeled or unlabeled from the pre-processed images 540 are augmented with synthetic images 552 generated using augmentation control 554 executing one or more augmentation algorithms. Augmentation techniques are used to artificially increase the amount and/or type of training data by adding slightly modified synthetic copies of already existing training data or newly created synthetic data from existing training data. As described herein, inter-scanner and inter-laboratory differences may cause intensity and color variability within the digital images. Further, poor scanning may lead to gradient changes and blur effects, assay staining may create stain artifacts such as background wash, and different tissue/patient samples may have variances in cell size. These variations and perturbations can negatively affect the quality and reliability of deep learning and artificial intelligence networks. The augmentation techniques implemented in augmentation stage 517 act as a regularizer for these variations and perturbations and help reduce overfitting when training a machine learning model. It should be understood that the augmentation techniques described herein can be used as a regularizer for any number and type of variations and perturbations and is not limited to the various specific examples discussed herein.

### Intensity And Color Variability

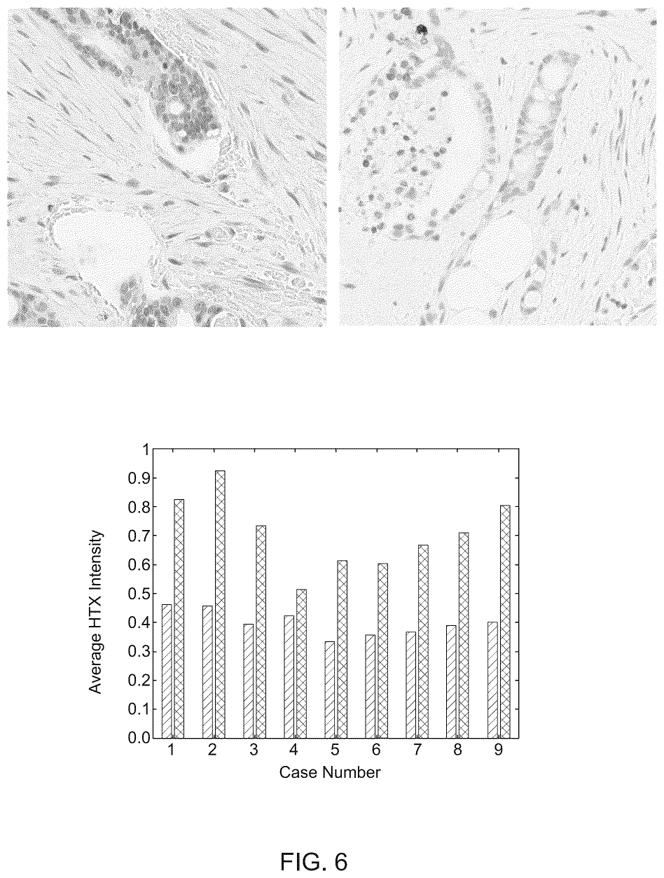

In previous studies, it was recognized that the staining protocols of different laboratories for biomarkers (e.g., the amphiregulin (AREG)/epiregulin (EREG) markers) were not the same, and the differences in the protocols would cause intensity and color variability (e.g., hematoxylin (HTX) intensities) in the samples and digital images thereof. FIG. 6 shows an EREG example using different staining protocols, which caused noticeable differences in the HTX intensity. These variances and perturbations in intensity and color caused problems for downstream machine learning models developed to analyze and classify the markers based on the staining of the samples. Especially in instances where a machine learning model was trained on images developed from a single protocol. Moreover, it was recognized that scanning quality or differences in scanning between scanners (e.g., between VENTANA® iScanHT® and VENTANA® DP200) were not the same, and the differences in the scanners could also cause intensity and color variation, Thus, a machine learning model developed for analysis using images scanned from one type of scanner may not work for analysis on images scanned from another type of scanner. This results in having to redevelop the entire machine learning model using images from the other type of scanner, which is expensive and time-consuming.

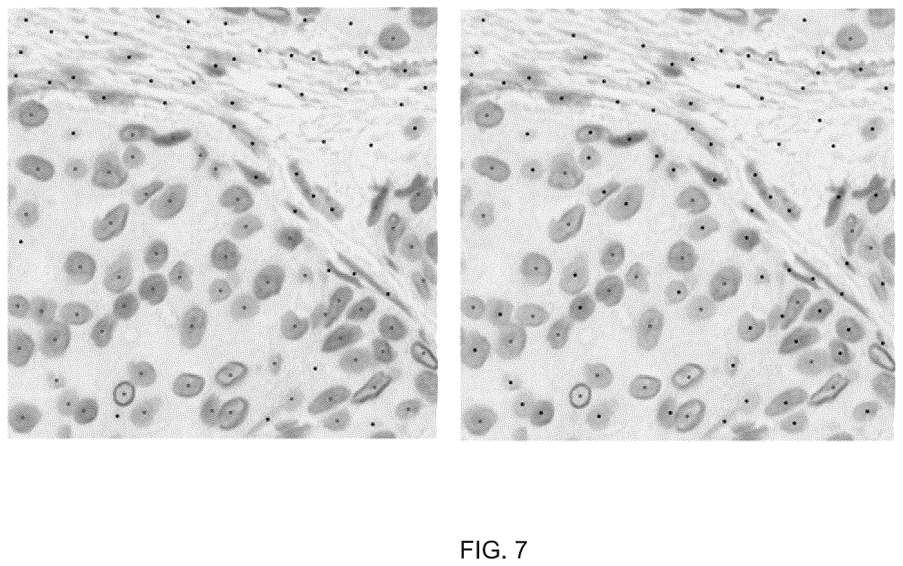

FIG. 7 shows that because of the small changes of intensities, the performance of a machine learning model is reduced. On the left side—all of ER positive cells were detected correctly (marked with red dots) by the machine learning model, but as seen on the right side—with only 10-20% intensity variances, the machine learning model failed to identify some of the ER positive cells. A conventional solution to this challenge is to collect data that are diverse enough to include as many variations as possible, for example, the use of federated learning to collect data from various sources, to improve the quality and robustness of the machine learning models. However, it is unrealistic to obtain all the image data from different scanners and laboratories required to train and improve the quality and robustness of the machine learning models. At the same time, for different companies and laboratories, the best hyper-parameters and models may be different, compromising a model in favor of particular data sources will ultimately affect the quality and robustness of the machine learning model to unseen data variations.

In order to overcome these challenges and others, techniques are disclosed herein to generate synthetic images 552 and perform training data augmentation before and/or during training to make the machine learning model generalize better and make the inferences more reliable. The synthetic images 552 are generated to simulate the intensity and color changes produced by different laboratories and scanners, and the synthetic images 552 and original images are used for adversarial training to improve the robustness of a machine learning model. The synthetic images 552 are created with one or more algorithms configured to create artificial intensity and/or color variation in the original images for augmenting the training data set and improving performance of the machine learning model, i.e., achieve better generalization/accuracy. The labels 545 from the original images may be transferred over to the synthetic images 552.

The one or more algorithms are configured to take as input an original image and obtain the spectral data for the original image produced by the image scanner, which can be decomposed into different acquisition portions or “channels” that represent the relative contributions of different stains or analytes used with the sample. The decomposition may be performed based on the principle of linear unmixing (also sometimes termed “spectral deconvolution” or “spectral decomposition”). According to this principle, the spectral data of the original spectral data cube is computationally compared to known reference spectra of, for example a particular analyte or stain; and then a linear unmixing algorithm is used to separate the known spectral components into channels that represent the intensity contribution (e.g., the net intensity) of each analyte or stain at each pixel.

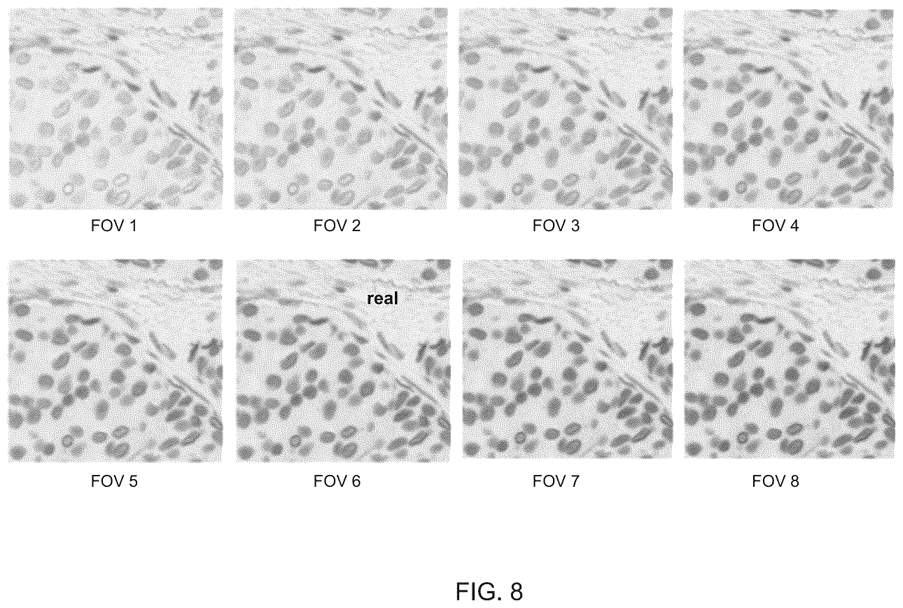

A digital color image typically has three values per pixel and the values represent a measure of the intensity and chrominance of light for each pixel. The one or more algorithms are configured, for each determined channel, to fix values of one or more variables (e.g., the chrominance or color information) while changing the values (increase or decreasing) of one or more other variables (e.g., the intensity). Each scheme of fixed and changed variables for the channels can be used to output a synthetic image (i.e., an adversarial example) from the original image. For example, in order to simulate intensity changes from different scanners/laboratories for AREG/EREG images, an algorithm may be developed to fix the chrominance or color information configuration of the HTX channel and the dabsyl ER channel, but change (increase and decrease) the intensity of the dabsyl ER channel by 10% to 20% while keeping the intensity of HTX channel fixed. FIG. 8 shows the original image (“real”) and seven synthetic images derived therefrom using such an algorithm.

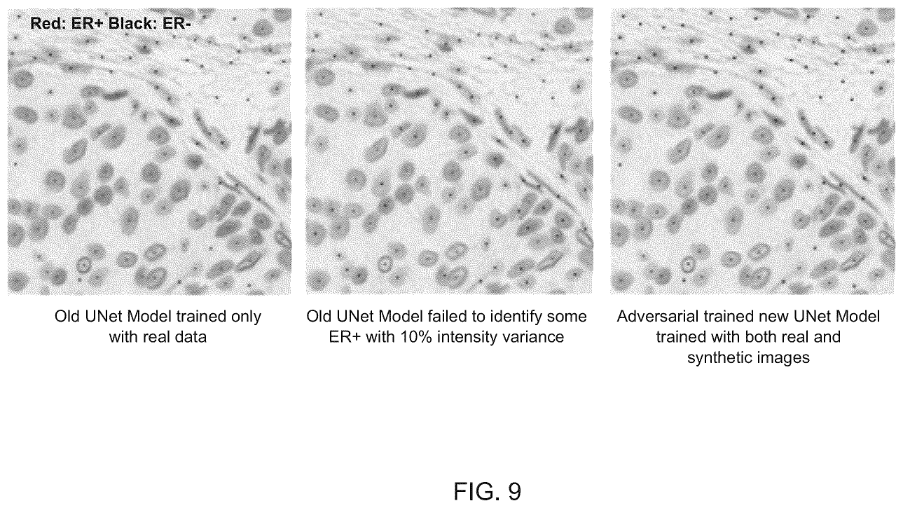

FIG. 9 shows that by generating synthetic images with small intensity changes (e.g., 10-20%) as described herein and training a machine learning algorithm using a combination of original images and the segmented or synthetic images, performance of the machine learning model (e.g., a U-Net model) can be improved. Specifically, 72 original images along with 504 augmented images were generated, for which there were 56874 cell labels (ER-positive tumor cells; ER-negative cells) annotated with a dot at the center of each cell nucleus. Training a U-Net model with all these images enabled the identification of the positive ER cells in images with small intensity changes (e.g., 10-20%) and increased model accuracy from 0.92 to 0.99 compared with training with the original images with no stain-intensity augmentation.

### Gradient Changes and Blur Effects

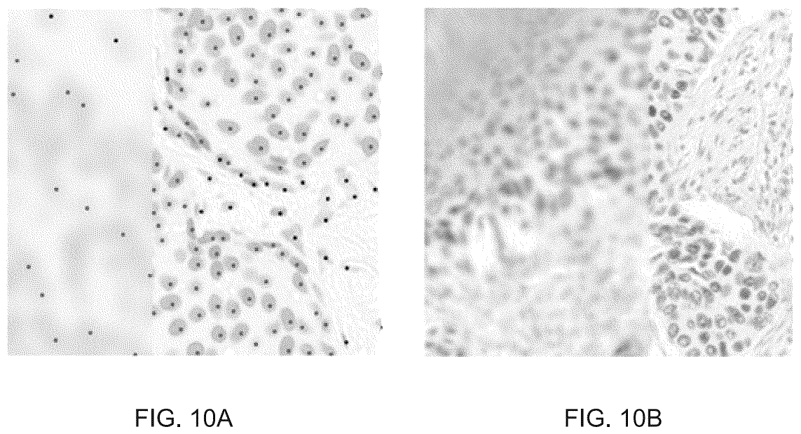

During tissue processing and slide scanning, slide artifacts, for example, out-of-focus artifacts (e.g., blurriness and gradient changes) can be easily introduced, which adversely affects the performance of machine learning models. For example, blurriness can lead to erroneous cell phenotype classification in deep-learning based biomarker analysis (see, e.g., FIG. 10A). A general strategy to avoid such model prediction errors is to develop either an automatic quality control (QC) approach or a manual procedure to identify these artifact regions and exclude them from downstream deep-learning analysis. However, such a strategy has the following drawbacks. First, it depends on a subjectively determined degree of adversity (e.g., blurriness) beyond which to flag as an adverse artifact. Such subjectivity not only causes inconsistent QC results across samples and analyzers, but also leads to a mismatch between analyzers' perception of out-of-focus artifacts, such as blurriness and the blur level, that causes considerable degradation of machine learning model performance. For example, pathologists have high tolerance of blurriness for certain biomarker assays (see, e.g., FIG. 10B) and may fail to flag the blurry regions, which are problematic for a machine learning model. Second, image regions below the adversity threshold vary in their focus quality, and further lead to variations in machine learning model performance.

In order to overcome these challenges and others, techniques are disclosed herein to generate synthetic images 552 and perform training data augmentation before and/or during training to make the machine learning model generalize better and make the inferences more reliable. The synthetic images 552 are generated to simulate the out-of-focus artifacts, and the synthetic images 552 and original images are used for adversarial training to improve the robustness of a machine learning model. The synthetic images 552 are created with one or more algorithms configured to create artificial out-of-focus artifacts in the original images for augmenting the training data set and improving performance of the machine learning model, i.e., achieve better generalization/accuracy. The labels 545 from the original images may be transferred over to the synthetic images 552.

The one or more algorithms are configured to take as input an original image and apply one or more out-of-focus effects to the entire image, a region of the image, a channel, or a FOV to generate synthetic images 552. The effects to be applied by the algorithm using one or more functions including smoothing, blurring, softening, and/or edge blurring. The smoothing function makes texture regions and object smoother and less defined. The blurring function such as a Gaussian blur applies a weighted average of the color values of the pixels in a kernel to a current pixel to be filtered, and by applying the function to all pixels to be filtered within regions and objects of the images the regions and objects become blurred. The softening function softens selected regions and objects by blending pixels within the objects and regions with the colors of pixels surrounding them. The edge blurring function blurs the edges of selected regions and objects by blending pixels of the edges of objects and regions with the colors of pixels immediately surrounding them. The one or more algorithms are configured, for each image, region, channel, or FOV to fix values one or more variables (e.g., the kernel size, change in pixel value, shift vertical, shift horizontal, etc.) while changing the values (increase or decreasing) one or more other variables (e.g., degree of smoothing, degree of blur, opacity, softness). Each scheme of fixed and changed variables for the image, region, channel, or FOV can be used to output a synthetic image (i.e., an adversarial example) from the original image. For example, in order to simulate blurring for images with poor scan quality, an algorithm may be developed to fix the smoothing, kernel size, and vertical/horizontal shifts within a region of an image, but change (increase and decrease) the degree of blur within the region.

The following example demonstrates pre-processing training data, augmenting training data, and using synthetic training data to effectively train a machine learning model to (i) reject adversarial example images, and (ii) detect, characterize and/or classify some or all regions of images that do not include adversarial example regions. For a cell phenotype classification, cell center detection along with phenotype classification (tumor positive for Ki-67 staining, tumor negative, and others) can be constructed as an image segmentation problem. Annotations are dots placed at the cell centers with a single pixel in size along with their phenotype class. To perform image segmentation, the dot annotations are expanded to disks as ground-truth labels. In this example, a U-Net architecture was used as the underlying model design and the architecture was modified by removing the last down-sampled block and reducing intermediate convolutional layer channel numbers by a factor of 4 to configure the machine learning model (Ki-67 classification model).

The training dataset was obtained from slide images of breast cancer tissue samples stained for Ki-67 or estrogen-receptor (ER) with DAB. The test dataset was obtained from the same tissue type, but all stained for Ki-67. Both training and test datasets included images from different breast cancer subtypes, including lobular carcinoma, ductal carcinoma and other rare subtypes. The datasets contained images of varying sizes at 20× magnification with a resolution of 0.5 μm/pixel. Patches of size 256×256 are randomly cropped at each training interaction from these images before feeding into the Ki-67 classification model.

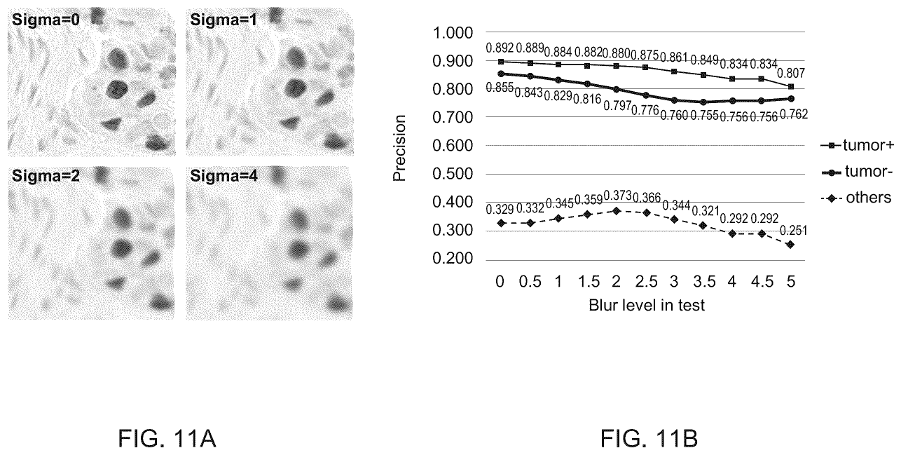

The performance changes of the trained Ki-67 classification model were quantitatively assessed on the test dataset in the presence of synthetically generated blurriness with Gaussian kernels at sigma values ranging from 0 to 5 (examples shown in the FIG. 11A). The test dataset was comprehensive and contains 385 image tiles sampled from 95 whole slide images. The precision of tumor cells negative for Ki-67 dropped from 0.855 at no blurriness to 0.816 at the sigma value of 1.5 and further dropped to below 0.8 at the sigma value of 2 (see, FIG. 11B). As an example, application in selection of a threshold level of adversity (e.g., a blur threshold), if a tolerance level of less than 0.04 is acceptable or desired in performance degradation, the threshold level of adversity could be set at 1.5 or 2 for the blurriness QC. Such an analysis approach enables the unbiased determination of blurriness threshold for preprocessing QC.

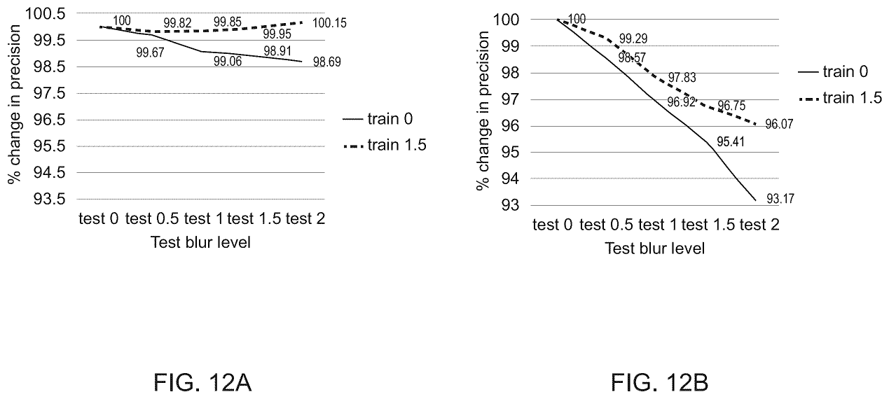

To build a classification model robust against blur levels below the aforementioned threshold level of adversity, the cell classification model was trained with training images blurred at a randomly selected sigma level in each epoch from various sigma ranges below 1.5 and each model was tested with test datasets blurred at the same sigma value. The performance degradations relative to testing with none-blurry images were smaller when applying blur augmentation (orange lines in FIGS. 12A and 12B) compared with no blur augmentation (light blue lines in FIGS. 12A and 12B) for both tumor positive and tumor negative classes. Such a data augmentation approach along with the quantitative assessment procedure thus demonstrate the effectiveness of such an adversarial robustness-training algorithm.

### Cell Size Variation

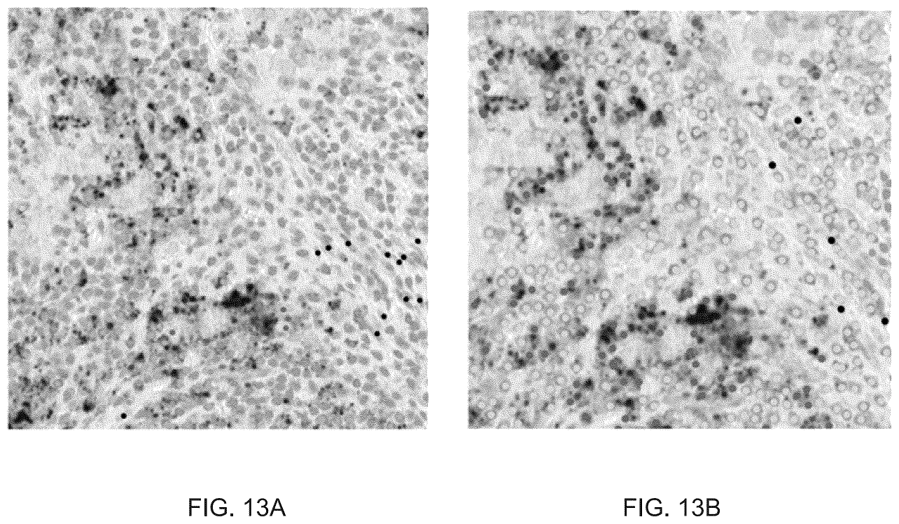

In digital pathology, cell size variation is a common perturbation that arises from heterogeneous morphologies of cancer, artifacts in histological preparation, and subject-wise variation. The robustness of machine learning models on cell size perturbation is expected, yet hard to achieve, in the real world. For example, a machine learning model was tested on variational cell sizes, which resulted in the poor classification results. FIG. 13A shows the classification results of machine learning model run on an image of an original PDL1 stained breast cancer sample and FIG. 13B shows the classification results of the machine learning model run on the same image with an augmented size of 120% and cropped back to the original size. Each marker was annotated with different colors (Cyan—IC (immune cell) negative, Yellow—IC positive, Pink—TC (Tumor cell) Negative, Red—TC positive, Black—Others). As shown, because of the size variation in the augmented image, the machine learning model misclassified all immune cells as tumor cells.

To address this challenge, the machine learning model was then trained by implementing a data augmentation technique described herein as a random resized crop where FOVs were resized to 110% and 120% then cropped back to the original input size. This resulted in the original training set tripling in size with a much broader sampling with respect to cell size, which helped the machine learning model to learn not to put as much emphasis on cell size during the classification. More specifically, the data augmentation technique generates synthetic images 552 and performs training data augmentation before and/or during training to make the machine learning model generalize better and make the inferences more reliable. The synthetic images 552 are generated to simulate various cell sizes, and the synthetic images 552 and original images are used for adversarial training to improve the robustness of a machine learning model. The synthetic images 552 are created with one or more algorithms configured to resize cells or objects within the original images for augmenting the training data set and improving performance of the machine learning model, i.e., achieve better generalization/accuracy. The labels 545 from the original images may be transferred over to the synthetic images 552.

The one or more algorithms are configured to take as input an original image, apply one or more scaling factors to the entire image, a region of the image, a channel, or a FOV, then crop the image to a predetermined size (e.g., the same size as the original image) to generate synthetic images 552. The one or more algorithms are configured, for each image, region, channel, or FOV to fix values one or more variables (e.g., color information, intensity, vertical or horizontal shift) while changing the values (increase or decreasing) one or more other variables (e.g., scaling factor). Each scheme of fixed and changed variables for the image, region, channel, or FOV can be used to output a synthetic image (i.e., an adversarial example) from the original image. For example, in order to simulate variable sizes for images, an algorithm may be developed to fix color information and intensity for a region or FOV of the image comprising immune cells, but change (increase and decrease) the scale of the region such that the size of the cells change without changing the color information and intensity of the immune cells. Alternatively, an algorithm may be developed to fix the degree of blur for a region or FOV of the image comprising immune cells, but change (increase and decrease) the scale and intensity of the region such that the size and intensity of the cells change without changing the focal clarity of the immune cells. Alternatively, an algorithm may be developed to fix all variables of the whole image but for the scale, which is changed (increase and decrease) such that the size of everything depicted in the image scales accordingly.

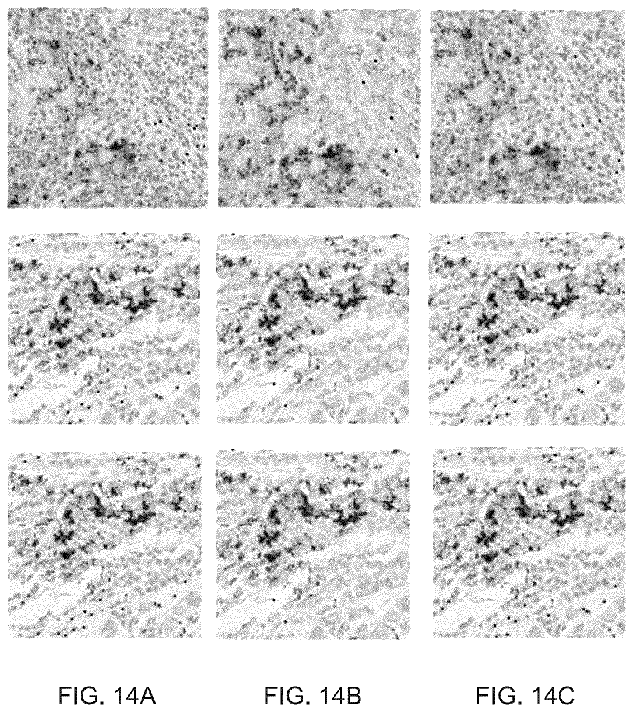

FIG. 14A shows the detection results of a trained machine learning model without variable size data argumentation on images, where cells have a typical size. The trained machine learning model was demonstrated to have the capability of accurately classifying cells having a typical size in the images. However, if little perturbations with only 110% to 120% of the cell size differences were added to the cells within the images, the trained machine learning model without variable size data argumentation failed to accurately classify the majority cells, as shown in FIG. 14B. The machine learning model was then trained with the variable size data argumentation methods of random resized crop where FOVs were resized to 110% and 120% and then cropped back to the original input size. In FIG. 14C, it showed that the machine learning model could correctly identify cells with variable changes. As a result of the variable size data argumentation methods, as FIGS. 14A-14C illustrates, classification results were corrected and the robustness of the machine learning model with respect to cell size perturbation was improved.

At training stage 520, labels 545 and corresponding pre-processed images 540 can be used by the training controller 565 to train machine learning algorithm(s) 555. To train an algorithm 555, the pre-processed images 540 are split into a subset of images 540a for training (e.g., 90%) and a subset of images 540b for validation (e.g., 10%). The splitting may be performed randomly (e.g., a 90/10% or 70/30%) or the splitting may be performed in accordance with a more complex validation technique such as K-Fold Cross-Validation, Leave-one-out Cross-Validation, Leave-one-group-out Cross-Validation, Nested Cross-Validation, or the like to minimize sampling bias and overfitting. The splitting may also be performed based on the inclusion of augmented or synthetic images 552 within the pre-processed images 540. For example, it may be beneficial to limit the number or ratio of synthetic images 552 included within the subset of images 540a for training. In some instances, the ratio of original images 535 to synthetic images 552 is maintained at 1:1, 1:2, 2:1, 1:3, 3:1, 1:4, or 4:1.

In some instances, the machine learning algorithm 555 includes a CNN, a modified CNN with encoding layers substituted by a residual neural network (“Resnet”), or a modified CNN with encoding and decoding layers substituted by a Resnet. In other instances, the machine learning algorithm 555 can be any suitable machine learning algorithm configured to localize, classify, and or analyze pre-processed images 540, such as a two-dimensional CNN (“2DCNN”), a Mask R-CNN, a U-Net, Feature Pyramid Network (FPN), a dynamic time warping (“DTW”) technique, a hidden Markov model (“HMM”), pure attention-based model, etc., or combinations of one or more of such techniques—e.g., vision transformer, CNN-HMM or MCNN (Multi-Scale Convolutional Neural Network). The computing environment 500 may employ the same type of machine learning algorithm or different types of machine learning algorithms trained to detect and classify different cells. For example, computing environment 500 can include a first machine learning algorithm (e.g., a U-Net) for detecting and classifying PD1. The computing environment 500 can also include a second machine learning algorithm (e.g., a 2DCNN) for detecting and classifying Cluster of Differentiation 68 (“CD68”). The computing environment 500 can also include a third machine learning algorithm (e.g., a U-Net) for combinational detecting and classifying PD1 and CD68. The computing environment 500 can also include a fourth machine learning algorithm (e.g., a HMM) for diagnosis of disease for treatment or a prognosis for a subject such as a patient. Still other types of machine learning algorithms may be implemented in other examples according to this disclosure.

The training process for the machine learning algorithm 555 includes selecting hyperparameters for the machine learning algorithm 555 from the parameter data store 563, inputting the subset of images 540a (e.g., labels 545 and corresponding pre-processed images 540) into the machine learning algorithm 555, and performing iterative operations to learn a set of parameters (e.g., one or more coefficients and/or weights) for the machine learning algorithms 555. The hyperparameters are settings that can be tuned or optimized to control the behavior of the machine learning algorithm 555. Most algorithms explicitly define hyperparameters that control different aspects of the algorithms such as memory or cost of execution. However, additional hyperparameters may be defined to adapt an algorithm to a specific scenario. For example, the hyperparameters may include the number of hidden units of an algorithm, the learning rate of an algorithm (e.g., 1e-4), the convolution kernel width, or the number of kernels for an algorithm. In some instances, the number of model parameters are reduced per convolutional and deconvolutional layer and/or the number of kernels are reduced per convolutional and deconvolutional layer by one half as compared to typical CNNs.

The subset of images 540a may be input into the machine learning algorithm 555 as batches with a predetermined size. The batch size limits the number of images to be shown to the machine learning algorithm 555 before a parameter update can be performed. Alternatively, the subset of images 540a may be input into the machine learning algorithm 555 as a time series or sequentially. In either event, in the instance that augmented or synthetic images 552 are included within the pre-processed images 540a, the number of original images 535 versus the number of synthetic images 552 included within each batch or the manner in which original images 535 and the synthetic images 552 are fed into the algorithm (e.g., every other batch or image is an original batch of images or original image) can be defined as a hyperparameter.

Each parameter is a tunable variable, such that a value for the parameter is adjusted during training. For example, a cost function or objective function may be configured to optimize accurate classification of depicted representations, optimize characterization of a given type of feature (e.g., characterizing a shape, size, uniformity, etc.), optimize detection of a given type of feature, and/or optimize accurate localization of a given type of feature. Each iteration can involve learning a set of parameters for the machine learning algorithms 555 that minimizes or maximizes a cost function for the machine learning algorithms 555 so that the value of the cost function using the set of parameters is smaller or larger than the value of the cost function using another set of parameters in a previous iteration. The cost function can be constructed to measure the difference between the outputs predicted using the machine learning algorithms 555 and the labels 545 contained in the training data. Once the set of parameters are identified, the machine learning algorithms 555 has been trained and can be utilized for its designed purpose such as localization and/or classification.

The training iterations continue until a stopping condition is satisfied. The training-completion condition may be configured to be satisfied when (for example) a predefined number of training iterations have been completed, a statistic generated based on testing or validation exceeds a predetermined threshold (e.g., a classification accuracy threshold), a statistic generated based on confidence metrics (e.g., an average or median confidence metric or a percentage of confidence metrics that are above a particular value) exceeds a predefined confidence threshold, and/or a user device that had been engaged in training review closes a training application executed by the training controller 565. The validation process may include iterative operations of inputting images from the subset of images 540b into the machine learning algorithm 555 using a validation technique such as K-Fold Cross-Validation, Leave-one-out Cross-Validation, Leave-one-group-out Cross-Validation, Nested Cross-Validation, or the like to tune the hyperparameters and ultimately find the optimal set of hyperparameters. Once the optimal set of hyperparameters are obtained, a reserved test set of images from the subset of images 540b are input the machine learning algorithm 555 to obtain output, and the output is evaluated versus ground truth using correlation techniques such as Bland-Altman method and the Spearman's rank correlation coefficients and calculating performance metrics such as the error, accuracy, precision, recall, receiver operating characteristic curve (ROC), etc. In some instances, new training iterations may be initiated in response to receiving a corresponding request from a user device or a triggering condition (e.g., drift is determined within a trained machine learning model 560).

As should be understood, other training/validation mechanisms are contemplated and may be implemented within the computing environment 500. For example, the machine learning algorithm 555 may be trained and hyperparameters may be tuned on images from the subset of images 540a and the images from the subset of images 540b may only be used for testing and evaluating performance of the machine learning algorithm 555. Moreover, although the training mechanisms described herein focus on training a new machine learning algorithm 555. These training mechanisms can also be utilized to fine tune existing machine learning models 560 trained from other datasets. For example, in some instances, machine learning models 560 might have been pre-trained using images of other objects or biological structures or from sections from other subjects or studies (e.g., human trials or murine experiments). In those cases, the machine learning models 560 can be used for transfer learning and retrained/validated using the pre-processed images 540.

The trained machine learning model 560 can then be used (at result generation stage 525) to process new pre-processed images 540 to generate predictions or inferences such as predict cell centers and/or location probabilities, classify cell types, generate cell masks (e.g., pixel-wise segmentation masks of the image), predict a diagnosis of disease or a prognosis for a subject such as a patient, or a combination thereof. In some instances, the masks identify a location of depicted cells associated with one or more biomarkers. For example, given a tissue stained for a single biomarker the trained machine learning model 560 may be configured to: (i) infer centers and/or locations of cells, (ii) classify cells based on features of a staining pattern associated with the biomarker, and (iii) output a cell detection mask for the positive cells and a cell detection mask for the negative cells. By way of a another example, given a tissue stained for two biomarkers the trained machine learning model 560 may be configured to: (i) infer centers and/or locations of cells, (ii) classify cells based on features of staining patterns associated with the two biomarkers, and (iii) output a cell detection mask for cells positive for the first biomarker, a cell detection mask for cells negative for the first biomarker, a cell detection mask for cells positive for the second biomarker, and a cell detection mask for cells negative for the second biomarker. By way of another example, given a tissue stained for a single biomarker the trained machine learning model 560 may be configured to: (i) infer centers and/or locations of cells, (ii) classify cells based on features of cells and a staining pattern associated with the biomarker, and (iii) output a cell detection mask for the positive cells and a cell detection mask for the negative cells code, and a mask cells classified as tissue cells.

In some instances, an analysis controller 580 generates analysis results 585 that are availed to an entity that requested processing of an underlying image. The analysis result(s) 585 may include the masks output from the trained machine learning models 560 overlaid on the new pre-processed images 540. Additionally, or alternatively, the analysis results 585 may include information calculated or determined from the output of the trained machine learning models such as whole-slide tumor scores. In exemplary embodiments, the automated analysis of tissue slides use the assignee VENTANA's FDA-cleared 510(k) approved algorithms. Alternatively, or in addition, any other automated algorithms may be used to analyze selected regions of images (e.g., masked images) and generate scores. In some embodiments, the analysis controller 580 may further respond to instructions of a pathologist, physician, investigator (e.g., associated with a clinical trial), subject, medical professional, etc. received from a computing device. In some instances, a communication from the computing device includes an identifier of each of a set of particular subjects, in correspondence with a request to perform an iteration of analysis for each subject represented in the set. The computing device can further perform analysis based on the output(s) of the machine learning model and/or the analysis controller 580 and/or provide a recommended diagnosis/treatment for the subject(s).

It will be appreciated that the computing environment 500 is exemplary, and the computing environment 500 with different stages and/or using different components are contemplated. For example, in some instances, a network may omit pre-processing stage 510, such that the images used to train an algorithm and/or an image processed by a model are raw images (e.g., from image data store). As another example, it will be appreciated that each of pre-processing stage 510 and training stage 520 can include a controller to perform one or more actions described herein. Similarly, while labeling stage 515 is depicted in association with labeling controller 550 and while result generation stage 525 is depicted in association with analysis controller 580, a controller associated with each stage may further or alternatively facilitate other actions described herein other than generation of labels and/or generation of analysis results. As yet another example, the depiction of computing environment 500 shown in FIG. 5 lacks a depicted representation of a device associated with a programmer (e.g., that selected an architecture for machine learning algorithm 555, defined how various interfaces would function, etc.), a device associated with a user providing initial labels or label review (e.g., at labeling stage 515), and a device associated with a user requesting model processing of a given image (which may be a same user or a different user as one who had provided initial labels or label reviews). Despite the lack of the depiction of these devices, computing environment 500 may involve the use one, more or all of the devices and may, in fact, involve the use of multiple devices associated with corresponding multiple users providing initial labels or label review and/or multiple devices associated with corresponding multiple users requesting model processing of various images.

### V. Techniques for Training a Machine Learning Algorithm Using Adversarial Examples

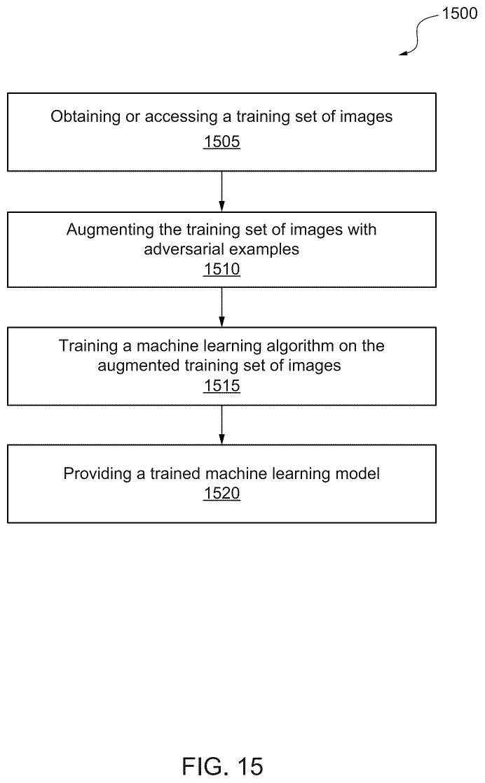

FIG. 15 shows a flowchart illustrating a process 1500 for using a training set of images augmented with adversarial examples to train a machine learning algorithm (e.g., a modified U-Net) in accordance with various embodiments. The process 1500 depicted in FIG. 15 may be implemented in software (e.g., code, instructions, program) executed by one or more processing units (e.g., processors, cores) of the respective systems, hardware, or combinations thereof. The software may be stored on a non-transitory storage medium (e.g., on a memory device). The process 1500 presented in FIG. 15 and described below is intended to be illustrative and non-limiting. Although FIG. 15 depicts the various processing steps occurring in a particular sequence or order, this is not intended to be limiting. In certain alternative embodiments, the steps may be performed in some different order or some steps may also be performed in parallel. In certain embodiments, such as in the embodiments depicted in FIGS. 4 and 5, the processing depicted in FIG. 15 may be performed by as part of the training stage (e.g., algorithm training 520) to train a machine learning algorithm using a training set of images augmented with adversarial examples to generate a machine learning model configured to detect, characterize, classify, or a combination thereof some or all regions or objects within images.

Process 1500 starts at block 1505, at which a training set of images for biological samples are obtained or accessed by a computing device, (e.g., pre-processed images 540 of computing environment 500 described with respect to FIG. 5). In some instances, the training set of images are digital pathology images comprising one or more types of cells. The training set of images may depict cells having a staining pattern associated with a biomarker. In some instances, the training set of images depict cells having multiple staining patterns associated with multiple biomarkers. The training set of images may be annotated with labels for training (e.g., supervised, semi-supervised or weakly-supervised).

At block 1510, the training set of images are augmented with adversarial examples. The augmenting comprises inputting the training set of images into one or more adversarial algorithms, and applying the one or more adversarial algorithms to the training set of images in order to generate synthetic images as the adversarial examples. The one or more adversarial algorithms are configured, for each of the images, one or more regions of interest within the images, one or more channels of the images, or one or more fields of view within the images, to fix values of one or more variables while changing the values of one or more other variables to generate the synthetic images with various levels of one or more adversarial features. The augmenting further includes generating augmented batches of images comprising images from the training set of images and the synthetic images from the adversarial examples.

In some instances, the one or more other variables are intensity, chrominance, or both for pixels in each of the images, the one or more regions of interest within the images, the one or more channels of the images, or the one or more fields of view within the images. In other instances, the one or more other variables are a degree of smoothing, a degree of blur, a degree of opacity, a degree of softness, or any combination thereof for pixels in each of the images, the one or more regions of interest within the images, the one or more channels of the images, or the one or more fields of view within the images. In other instances, the one or more other variables are a scaling factor for changing a size of objects depicted in each of the images, the one or more regions of interest within the images, the one or more channels of the images, or the one or more fields of view within the images.

In some instances, the one or more adversarial algorithms are configured, for a first channel of the one or more channels of the images, to fix the values of the one or more variables while changing the values of a first variable of the one or more other variables, and for a second channel of the one or more channels of the images, to fix the values of the one or more variables while changing the values of a second variable of the one or more other variables. In other instances, the one or more adversarial algorithms are configured, for a first channel of the one or more channels of the images, to fix the values of a first variable of the one or more variables while changing the values of a first variable of the one or more other variables, and for a second channel of the one or more channels of the images, to fix the values of a second variable of the one or more variables while changing the values of a second variable of the one or more other variables.

The training comprises performing iterative operations to learn a set of parameters to detect, characterize, classify, or a combination thereof some or all regions or objects within the augmented batches of images that maximizes or minimizes a cost function. Each iteration involves finding the set of parameters for the machine learning algorithm so that a value of the cost function using the set of parameters is larger or smaller than a value of the cost function using another set of parameters in a previous iteration. The cost function is constructed to measure a difference between predictions made for some or all the regions or the objects using the machine learning algorithm and ground truth labels provided for the augmented batches of images.

At block 1515, a machine learning algorithm is trained on the augmented batches of images to generate a machine learning model configured to detect, characterize, classify, or a combination thereof some or all regions or objects within new images. Output of the training comprises a trained machine learning model with a learned set of parameters associated with nonlinear relationships that derived a minimum value of the cost function or the maximum value of the cost function from all iterations.

At block 1520, the trained machine learning model is provided. For example, the trained machine learning model may be deployed for execution in an image analysis environment, as described with respect to FIG. 5.

### VI. Techniques for Training a Machine Learning Model to Exclude Adverse Regions

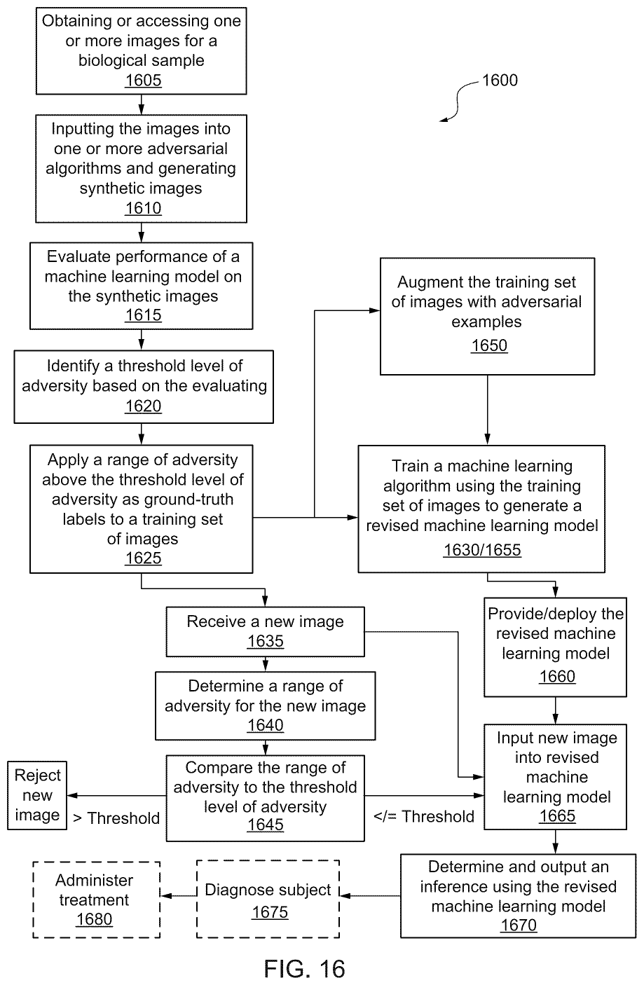

FIG. 16 shows a flowchart illustrating a process 1600 for using a threshold level of adversity to train a machine learning algorithm (e.g., a modified U-Net) in accordance with various embodiments. The process 1600 depicted in FIG. 16 may be implemented in software (e.g., code, instructions, program) executed by one or more processing units (e.g., processors, cores) of the respective systems, hardware, or combinations thereof. The software may be stored on a non-transitory storage medium (e.g., on a memory device). The process 1600 presented in FIG. 16 and described below is intended to be illustrative and non-limiting. Although FIG. 16 depicts the various processing steps occurring in a particular sequence or order, this is not intended to be limiting. In certain alternative embodiments, the steps may be performed in some different order or some steps may also be performed in parallel. In certain embodiments, such as in the embodiments depicted in FIGS. 4 and 5, the processing depicted in FIG. 16 may be performed by as part of the training stage (e.g., algorithm training 520) to train a machine learning algorithm and the result generation stage (e.g., result generation 525) to generate a revised machine learning model configured to identify adverse regions and exclude the adverse regions from downstream processing or analysis.

Process 1600 starts at block 1605, at which a set of digital pathology images are accessed or obtained. In some instances, the digital pathology images comprise one or more types of cells. The images may depict cells comprising a staining pattern of one or more biomarkers. In certain instances, the one or more images depict cells comprising a staining pattern of a biomarker and another biomarker. As described with respect to FIG. 1, the images can be pre-processed by immunochemical staining techniques (e.g., IF) so that specific proteins and organelles in the biological sample are visible for an analysis system to process and analyze. In some embodiments, the images are stained using multiple stains or binders such as antibodies so that information about different biomarkers can be reported under multichannel analysis or similar techniques.

At block 1610, the set of digital pathology images are input into one or more adversarial algorithms. The one or more adversarial algorithms are applied to the set of digital pathology images in order to generate synthetic images. The one or more adversarial algorithms are configured, for each of the images, one or more regions of interest within the images, one or more channels of the images, or one or more fields of view within the images, to fix values of one or more variables while changing the values of one or more other variables to generate the synthetic images with various levels of one or more adversarial features. In some instances, the image is initially transformed/processed by some computation (e.g. converted from RGB to grayscale), and thereafter the one or more adversarial algorithms are configured, for each of the pre-processed images, one or more regions of interest within the pre-processed images, one or more channels of the pre-processed images, or one or more fields of view within the pre-processed images, to fix values of one or more variables while changing the values of one or more other variables to generate the synthetic images with various levels of one or more adversarial features.

At block 1615, the performance of a machine learning model to make an inference with respect to some or all regions or objects within the set of digital pathology images and the synthetic images is evaluated. For example, the performance may be evaluated based on the ability of the machine learning model to accurately make the inference.

At block 1620, a threshold level of adversity at which the machine learning model can no longer accurately make the inference is identified based on the evaluating. For example, if accuracy is defined as an inference with a confidence score above 80%, then the level of adversity (e.g., a blur level of 2.0) for images that machine learning model provides 80% confidence would be identified as the threshold level of adversity at which the machine learning model can no longer accurately make the inference.

At block 1625, a range of adversity above the identified threshold level is applied as a ground-truth label in a training set of images. For example, during the annotation and labeling process of images, any image, region of interest, object, or field of view identified as having a range of adversity above the identified threshold level (e.g., a blur level of 2.0) would receive a ground-truth label corresponding to adversarial features exceeding the identified threshold level.

At block 1630, a machine learning algorithm is trained using the training set of images to generate a revised machine learning model configured to identify adverse regions and exclude the adverse regions from downstream processing or analysis. The revised machine learning model may be further configured to detect, characterize, classify, or a combination thereof some regions or objects within new images without consideration of the adverse regions.

At block 1635, a new image is received. The new image may be divided into image patches of a predetermined size. For example, whole-slide images typically have random sizes and a machine learning algorithm such as a modified CNN learns more efficiently (e.g., parallel computing for batches of images with the same size; memory constraints) on a normalized image size, and thus the image may be divided into image patches with a specific size to optimize analysis. In some embodiments, the image is split into image patches having a predetermined size of 64 pixels×64 pixels, 128 pixels×128 pixels, 256 pixels×256 pixels, or 512 pixels×512 pixels.

At block 1640, a range of adversity for the new image is determined. For example, a determination may be made as to an average range of adversity for the image based on levels of adversity throughout the image (e.g., levels of blurriness throughout the image). At block 1645, the range of adversity is compared to the threshold level of adversity, and when the range of adversity for the new image is greater than the threshold level of adversity, the new image is rejected; and when the range of adversity for the new image is less than or equal to the threshold level of adversity, the new image is input into the revised machine learning model.

At block 1650, the training set of images may be augmented with adversarial examples. The augmenting comprises inputting the training set of images into one or more adversarial algorithms, and applying the one or more adversarial algorithms to the training set of images in order to generate synthetic images as the adversarial examples. The one or more adversarial algorithms are configured, for each of the images, one or more regions of interest within the images, one or more channels of the images, or one or more fields of view within the images, to fix values of one or more variables while changing the values of one or more other variables to generate the synthetic images with various levels of one or more adversarial features. The augmenting further includes generating augmented batches of images comprising images from the training set of images and the synthetic images from the adversarial examples.

In some instances, the one or more other variables are intensity, chrominance, or both for pixels in each of the images, the one or more regions of interest within the images, the one or more channels of the images, or the one or more fields of view within the images. In other instances, the one or more other variables are a degree of smoothing, a degree of blur, a degree of opacity, a degree of softness, or any combination thereof for pixels in each of the images, the one or more regions of interest within the images, the one or more channels of the images, or the one or more fields of view within the images. In other instances, the one or more other variables are a scaling factor for changing a size of objects depicted in each of the images, the one or more regions of interest within the images, the one or more channels of the images, or the one or more fields of view within the images.

In some instances, the one or more adversarial algorithms are configured, for a first channel of the one or more channels of the images, to fix the values of the one or more variables while changing the values of a first variable of the one or more other variables, and for a second channel of the one or more channels of the images, to fix the values of the one or more variables while changing the values of a second variable of the one or more other variables. In other instances, the one or more adversarial algorithms are configured, for a first channel of the one or more channels of the images, to fix the values of a first variable of the one or more variables while changing the values of a first variable of the one or more other variables, and for a second channel of the one or more channels of the images, to fix the values of a second variable of the one or more variables while changing the values of a second variable of the one or more other variables.

The training comprises performing iterative operations to learn a set of parameters to detect, characterize, classify, or a combination thereof some or all regions or objects within the augmented batches of images that maximizes or minimizes a cost function. Each iteration involves finding the set of parameters for the machine learning algorithm so that a value of the cost function using the set of parameters is larger or smaller than a value of the cost function using another set of parameters in a previous iteration. The cost function is constructed to measure a difference between predictions made for some or all the regions or the objects using the machine learning algorithm and ground truth labels provided for the augmented batches of images.

At block 1655, the machine learning algorithm may be trained on the augmented batches of images to generate a machine learning model configured to detect, characterize, classify, or a combination thereof some or all regions or objects within new images without consideration of the adverse regions. Output of the training comprises a trained machine learning model with a learned set of parameters associated with nonlinear relationships that derived a minimum value of the cost function or the maximum value of the cost function from all iterations.

At block 1660, the trained machine learning model is provided. For example, the trained machine learning model may be deployed for execution in an image analysis environment, as described with respect to FIG. 5.

At block 1665, the image or the image patches are input into the revised machine learning model for further analysis. At block 1670, the revised machine learning model detects, characterizes, classifies, or a combination thereof some or all regions or objects within the image or the image patches, and outputs an inference based on the detecting, characterizing, classifying, or a combination thereof.

At optional block 1675, a diagnosis of a subject associated with the image or the image patches is determined based on the inference output by the revised machine learning model.

At optional block 1680, a treatment is administered to the subject associated with the image or the image patches. In some instances, the treatment is administered based on (i) inference output by the machine learning model or the revised machine learning model, and/or (ii) the diagnosis of the subject determined at block 1675.

### VII. Additional Considerations

Some embodiments of the present disclosure include a system including one or more data processors. In some embodiments, the system includes a non-transitory computer readable storage medium containing instructions which, when executed on the one or more data processors, cause the one or more data processors to perform part or all of one or more methods and/or part or all of one or more processes disclosed herein. Some embodiments of the present disclosure include a computer-program product tangibly embodied in a non-transitory machine-readable storage medium, including instructions configured to cause one or more data processors to perform part or all of one or more methods and/or part or all of one or more processes disclosed herein.

The terms and expressions which have been employed are used as terms of description and not of limitation, and there is no intention in the use of such terms and expressions of excluding any equivalents of the features shown and described or portions thereof, but it is recognized that various modifications are possible within the scope of the invention claimed. Thus, it should be understood that although the present invention as claimed has been specifically disclosed by embodiments and optional features, modification and variation of the concepts herein disclosed may be resorted to by those skilled in the art, and that such modifications and variations are considered to be within the scope of this invention as defined by the appended claims.

The ensuing description provides preferred exemplary embodiments only, and is not intended to limit the scope, applicability or configuration of the disclosure. Rather, the ensuing description of the preferred exemplary embodiments will provide those skilled in the art with an enabling description for implementing various embodiments. It is understood that various changes may be made in the function and arrangement of elements without departing from the spirit and scope as set forth in the appended claims.

Specific details are given in the following description to provide a thorough understanding of the embodiments. However, it will be understood that the embodiments may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

What is claimed is:

1. A computer-implemented method comprising:
obtaining, at a data processing system, a training set of images for training a machine learning algorithm to detect, characterize, classify, or a combination thereof some or all regions or objects within the images;
augmenting, by the data processing system, the training set of images with adversarial examples, wherein the augmenting comprises:
inputting the training set of images into one or more adversarial algorithms,
applying the one or more adversarial algorithms to the training set of images in order to generate synthetic images as the adversarial examples, wherein the one or more adversarial algorithms are configured, for each of the images, one or more regions of interest within the images, one or more channels of the images, or one or more fields of view within the images, to fix values of one or more variables while changing the values of one or more other variables to generate the synthetic images with various levels of one or more adversarial features, and
generating augmented batches of images comprising images from the training set of images and the synthetic images from the adversarial examples; and
training, by the data processing system, the machine learning algorithm using the augmented batches of images to generate a machine learning model configured to detect, characterize, classify, or a combination thereof some or all regions or objects within new images.

2. The method of claim 1, wherein the training set of images are digital pathology images comprising one or more types of cells.

3. The method of claim 1, wherein the one or more other variables are intensity, chrominance, or both for pixels in each of the images, the one or more regions of interest within the images, the one or more channels of the images, or the one or more fields of view within the images.

4. The method of claim 1, wherein the one or more other variables are a degree of smoothing, a degree of blur, a degree of opacity, a degree of softness, or any combination thereof for pixels in each of the images, the one or more regions of interest within the images, the one or more channels of the images, or the one or more fields of view within the images.

5. The method of claim 1, wherein the one or more other variables are a scaling factor for changing a size of objects depicted in each of the images, the one or more regions of interest within the images, the one or more channels of the images, or the one or more fields of view within the images.

6. The method of claim 1, wherein the one or more adversarial algorithms are configured, for a first channel of the one or more channels of the images, to fix the values of the one or more variables while changing the values of a first variable of the one or more other variables, and for a second channel of the one or more channels of the images, to fix the values of the one or more variables while changing the values of a second variable of the one or more other variables.

7. The method of claim 1, wherein the one or more adversarial algorithms are configured, for a first channel of the one or more channels of the images, to fix the values of a first variable of the one or more variables while changing the values of a first variable of the one or more other variables, and for a second channel of the one or more channels of the images, to fix the values of a second variable of the one or more variables while changing the values of a second variable of the one or more other variables.

8. The method of claim 1, wherein the training comprises performing iterative operations to learn a set of parameters to detect, characterize, classify, or a combination thereof some or all regions or objects within the augmented batches of images that maximizes or minimizes a cost function, wherein each iteration involves finding the set of parameters for the machine learning algorithm so that a value of the cost function using the set of parameters is larger or smaller than a value of the cost function using another set of parameters in a previous iteration, and wherein the cost function is constructed to measure a difference between predictions made for some or all the regions or the objects using the machine learning algorithm and ground truth labels provided for the augmented batches of images.

9. The method of claim 1, further comprising providing the machine learning model.

10. The method of claim 9, wherein the providing comprises deploying the machine learning model in a digital pathology system.

11. A computer-implemented method comprising:
obtaining, by a data processing system, a set of digital pathology images comprising one or more types of cells;
inputting, by the data processing system, the set of digital pathology images into one or more adversarial algorithms;
applying, by the data processing system, the one or more adversarial algorithms to the set of digital pathology images in order to generate synthetic images, wherein the one or more adversarial algorithms are configured, for each of the images, one or more regions of interest within the images, one or more channels of the images, or one or more fields of view within the images, to fix values of one or more variables while changing the values of one or more other variables to generate the synthetic images with various levels of one or more adversarial features;
evaluating, by the data processing system, performance of a machine learning model to make an inference with respect to some or all regions or objects within the set of digital pathology images and the synthetic images;
identifying, by the data processing system, a threshold level of adversity at which the machine learning model can no longer accurately make the inference based on the evaluating;
applying, by the data processing system, a range of adversity above the identified threshold level as a ground-truth label in a training set of images; and
training, by the data processing system, a machine learning algorithm using the training set of images to generate a revised machine learning model configured to identify adverse regions and exclude the adverse regions from downstream processing or analysis.

12. The method of claim 11, wherein the revised machine learning model is further configured to detect, characterize, classify, or a combination thereof some regions or objects within new images without consideration of the adverse regions.

13. The method of claim 11, further comprising:
receiving, by the data processing system, a new image;
determining, by the data processing system, a range of adversity for the new image;
comparing, by the data processing system, the range of adversity to the threshold level of adversity;
when the range of adversity for the new image is greater than the threshold level of adversity, rejecting, by the data processing system, the new image; and
when the range of adversity for the new image is less than or equal to the threshold level of adversity, inputting, by the data processing system, the new image into the revised machine learning model.

14. The method of claim 11, further comprising:
augmenting, by the data processing system, the training set of images with adversarial examples, wherein the augmenting comprises:
inputting the training set of images into the one or more adversarial algorithms;
applying the one or more adversarial algorithms to the training set of images in order to generate synthetic images as the adversarial examples, wherein the one or more adversarial algorithms are configured, for each of the images, one or more regions of interest within the images, one or more channels of the images, or one or more fields of view within the images, to fix values of one or more variables while changing the values of one or more other variables based on the threshold level of adversity to generate the synthetic images with various levels of one or more adversarial features that are less than or equal to the threshold level of adversity; and
generating augmented batches of images comprising images from the training set of images and the synthetic images from the adversarial examples; and
training, by the data processing system, the machine learning algorithm using the augmented batches of images to generate the revised machine learning model configured to detect, characterize, classify, or a combination thereof some or all regions or objects within new images without consideration of the adverse regions.

15. The method of claim 14, wherein the training comprises performing iterative operations to learn a set of parameters to detect, characterize, classify, or a combination thereof some or all regions or objects within the augmented batches of images that maximizes or minimizes a cost function, wherein each iteration involves finding the set of parameters for the machine learning algorithm so that a value of the cost function using the set of parameters is larger or smaller than a value of the cost function using another set of parameters in a previous iteration, and wherein the cost function is constructed to measure a difference between predictions made for some or all the regions or the objects using the machine learning algorithm and ground truth labels provided for the augmented batches of images.

16. The method of claim 14, wherein the one or more other variables are intensity, chrominance, or both for pixels in each of the images; the one or more regions of interest within the images; the one or more channels of the images; the one or more fields of view within the images; a degree of smoothing, a degree of blur, a degree of opacity, a degree of softness, or any combination thereof for pixels in each of the images; the one or more regions of interest within the images; or a scaling factor for changing a size of objects depicted in each of the images.

17. The method of claim 11, further comprising:
receiving, by the data processing system, a new image;
inputting the new image into the machine learning model or the revised machine learning model;
detecting, characterizing, classifying, or a combination thereof, by the machine learning model or the revised machine learning model, some or all regions or objects within the new images; and
outputting, by the machine learning model or the revised machine learning model, an inference based on the detecting, characterizing, classifying, or a combination thereof.

18. The method of claim 17, further comprising:
determining, by a user, a diagnosis of a subject associated with the new image, wherein the diagnosis is determined based on the inference output by the machine learning model or the revised machine learning model.

19. The method of claim 18, further comprising:
administering, by the user, a treatment to the subject based on (i) inference output by the machine learning model or the revised machine learning model, and/or (ii) the diagnosis of the subject.

20. A system comprising:
one or more data processors; and
a non-transitory computer readable storage medium containing instructions which, when executed on the one or more data processors, cause the one or more data processors to perform operations comprising:
obtaining, at a data processing system, a training set of images for training a machine learning algorithm to detect, characterize, classify, or a combination thereof some or all regions or objects within the images;
augmenting, by the data processing system, the training set of images with adversarial examples, wherein the augmenting comprises:
inputting the training set of images into one or more adversarial algorithms,
applying the one or more adversarial algorithms to the training set of images in order to generate synthetic images as the adversarial examples, wherein the one or more adversarial algorithms are configured, for each of the images, one or more regions of interest within the images, one or more channels of the images, or one or more fields of view within the images, to fix values of one or more variables while changing the values of one or more other variables to generate the synthetic images with various levels of one or more adversarial features, and
generating augmented batches of images comprising images from the training set of images and the synthetic images from the adversarial examples; and
training, by the data processing system, the machine learning algorithm using the augmented batches of images to generate a machine learning model configured to detect, characterize, classify, or a combination thereof some or all regions or objects within new images.
